(19) United States
(12) Patent Application Publication
(10) Pub. No.: US 2018/0052987 A1
(43) Pub. Date: Feb. 22, 2018

(54) SERVER SYSTEM AND METHOD FOR CONTROLLING MULTIPLE SERVICE SYSTEMS

(71) Applicants: Chiba University, Chiba (JP); Safety Angle Inc., Chiba (JP)

(72) Inventors: Mitsuru TADA, Chiba (JP); Masayuki ITOI, Chiba (JP)

(21) Appl. No.: 15/531,003

(22) PCT Filed: Nov. 25, 2015
(86) PCT No.: PCT/JP2015/082991

§ 371 Date: Nov. 1, 2017

(30) Foreign Application Priority Data
Nov. 27, 2014 (JP) 2014-240462
Jan. 16, 2015 (JP) 2015-006662
Feb. 23, 2015 (JP) 2015-033330
Sep. 25, 2015 (JP) 2015-187644

(51) Int. Cl. G06F 21/41; H04L 29/06; H04L 29/08

(52) U.S. Cl. CPC G06F 21/41; H04L 63/126; H04L 63/10; H04L 63/083; H04L 67/14; H04L 63/20; H04L 63/0815

(57) ABSTRACT

Each of one or more information element groups as for each user in management information kept by a server system (C^{(j)}) includes mID (an ID that is shared with C^{(j)} and a service system (Sᵢ^{(j)}), and that is different for each user). C^{(j)} receives a request from a user terminal. C^{(j)} identifies, on the basis of the received request, one or more mIDs respectively corresponding to one or more service systems, from the management information, for the user for the user terminal. C^{(j)} sends, to each of the one or more Sᵢ^{(j)}, a request associated with the mID(s) corresponding to the Sᵢ^{(j)} among the identified one or more mIDs, and the control content(s) for the Sᵢ^{(j)}.

### TECHNICAL FIELD

The present invention generally relates to control of a service system.

### TECHNICAL BACKGROUND

Generally, identification codes are used for access control like authentication. The term “identification code” means any data used for access control, for example, authentication. The term “identification code” in this DESCRIPTION can mean “identification code” appearing in the description of “Act on Prohibition of Unauthorized Computer Access” (in Japan). We know “passwords” like one-time passwords as an example of “identification code”. We can present Patent Literature 1 (PTL 1) as an authentication technique.

### CITATION LIST

### Patent Literature

[PTL 1] JP3678417

### SUMMARY OF INVENTION

### Technical Problem

Impersonation crimes in the Internet happen frequently with password leakage, password cracking, and so on. Therefore, service system administrators often ask the system users to strengthen their passwords (and IDs) management, or to regularly change their passwords.

However, it is not easy, for a user using many service systems in the Internet, to manage his passwords (and IDs), for example, to manage his password (and IDs) for every service system he uses, and furthermore, to change their passwords regularly.

There are many users who cannot remember all passwords (and IDs) for the corresponding service systems. Such users set an identical password (and ID) for plural service systems, or keep their passwords (and IDs) in their notebooks, PCs, and so on. However, we cannot see these management manners are secure.

The problem given above can occur not only for passwords (and IDs) but also other identification codes (for example, one-time passwords).

On the other hand, we can see other problems given below, in the case where one user makes use of plural service systems.

For example, there can be a user who has a trouble in the viewpoint of convenience, that he/she has to give his/her information data to the first service system after getting the data from the second service system, in order to provide the data to the first service system.

Furthermore, there can be a user can have a fear the viewpoint of security, that someone else may impersonate him to access the service system he uses.

### Solution to Problem

Constructed is a server system (one or more computers) which can communicate with plural user terminals and plural service systems. A server system (for example, the control center machine) keeps management information including one or more information element groups for each user. Each of one or more information element groups is shared with the server system and a service system, and includes an ID (mID) that is different for each user. The server system receives a request from a user terminal. The server system identifies, on the basis of the request, one or more mIDs respectively corresponding to one or more service systems, from the management information, for the user for the user terminal. The server system sends, to each of the one or more service systems, a request associated with the mID(s) corresponding to the service system among the identified one or more IDs, and the control content(s) for the service system.

### Advantageous Effects of Invention

It is possible to securely enhance convenience for utilization of plural service systems.

### BRIEF DESCRIPTION OF DRAWINGS

FIG. 1 shows the overview of the authentication process according to Embodiment 1.

FIG. 2 shows an example of the construction of U_{M}.

FIG. 3 shows an example of the construction of U_{P}.

FIG. 4 shows an example of the construction of Sᵢ^{(j)} (S₁⁽¹⁾).

FIG. 5 shows an example of the construction of C^{(j)} (C⁽¹⁾).

FIG. 6 shows an example of the construction of uListᵢ^{(j)} (uList₁⁽¹⁾).

FIG. 7 shows an example of the construction of aListᵢ^{(j)} (aList₁⁽¹⁾).

FIG. 8 shows an example of the construction of pList.

FIG. 9 shows an example of the construction of sList^{(j)} (sList⁽¹⁾).

FIG. 10 shows an example of the construction of cList^{(j)} (cList⁽¹⁾).

FIG. 11 shows tpw provision by C⁽¹⁾.

FIG. 12 shows an example of the flow for First registration.

FIG. 13 shows an example of the flow for Second or further registration.

FIG. 14 shows an example of the flow for tpw issuance according to Embodiment 1.

FIG. 15 shows an example of the authentication system according to Embodiment 2.

FIG. 16 shows an example of pList.

FIG. 17 shows an example of the flow for tpw issuance according to Embodiment 2.

FIG. 18 shows an example of the flow for tpw issuance according to Embodiment 3.

FIG. 19 shows a concrete example of FIG. 18.

FIG. 20 shows an example of the flow for tpw issuance according to Embodiment 4.

FIG. 21 shows an example of the flow for tpw issuance according to Embodiment 5.

FIG. 22 shows an example of the flow for tpw deletion according to Embodiment 6.

FIG. 23 shows an example of the construction of uListᵢ^{(j)} according to Embodiment 7.

FIG. 24 shows an example of the construction of aList^{(j)} according to Embodiment 7.

FIG. 25 shows an example of the flow for authentication and sharing according to Embodiment 8.

FIG. 26 shows an example of the abstract of the identification code management.

FIG. 27 shows examples of the construction of the shutter system.

FIG. 28 shows an example of the flow for each of Registration procedure #1, Registration procedure #2, and Authentication shutter operation procedure.

FIG. 29 shows an example of the flow for Login procedure.

FIG. 30 shows examples of the screen transition.

FIG. 31 shows an example of the flow for the registration according to Embodiment 8.

### DESCRIPTION OF EMBODIMENT

Some embodiments are described as follows.

Then, we provide a password as an example of the identification code common among plural service systems is password. As we describe below, common passwords are associated with some restrictions like such as at least one of the expiration date and the frequency of possible use. In our embodiments, we provide, as an example of common passwords, a one-time password which is available during the very day when it is issued, and which has no limit for the number of use. Here we mean, by “one-time”, at least the former of that it has some restriction for the period it can be used, and that it can be used only once. Hereafter, we often call such a password “a common 1-day password”. As we describe later, in some embodiments, a password does not have to be a tpw (a common 1-day password). For example, in some embodiments, a password can be a temporary password of another type, or can be a usual fixed password that can be used only at a certain service system.

In the following description, we use the term “AAA-list” to represent information data, but it can be realized with an arbitrary data structure. Namely, we can call an AAA-list by the term “an AAA-data” in order to mean that the data structure does not matter about that information data. Still more, the configurations of lists we show are only examples. Hence two or more lists can be merged to be a one list, and one list can be divided into plural lists.

In the following description, “storage unit” may be one or more storage devices including memories. For example, a storage unit may be at least a main storage device of a main storage device (typically, a volatile memory) and an auxiliary storage device (typically, a nonvolatile memory). An auxiliary storage device may be, for example, a HDD (Hard Disk Drive) or a SSD (Solid State Drive).

In the following description, “processor” may typically be a microprocessor (for example, CPU (Central Processing Unit)), and can include a private hardware circuit (for example, ASIC (Application Specific Integrated Circuit)) which executes a part of the process such as encryption or decryption.

In at least one embodiment, a control center machine which issues common 1-day passwords, intervenes in the two entities, a service system and a user, and thereby an authentication among three entities is executed. In the description of the embodiments, we adopt the following notations. Here, generally there are one or more users, but for simplicity of the description, we mention the embodiments under the condition that the number of users is one, because in the embodiments, no transmission is yielded among users.
tpw: a common 1-day password
C^{(j)}: a control center machine (where j is an integer more than or equal to 1 (j=1, 2, 3, . . . )) (A manager or an owner of a control center machine may be an individual, a private company, or a government and municipal office.)
Sᵢ: a service system (where i is an integer more than or equal to 1 (i=1, 2, 3, . . . )) (A manager or an owner of a service system may be an individual, a private company, or a government and municipal office.)
Sᵢ^{(j)}: Sᵢ registered in C^{(j)}
U: a user
U_{P}: a first user terminal (a user device to access to Sᵢ^{(j)}, for example, a personal computer, PC)
U_{M}: the second user terminal (a user terminal which is used for sending requests of tpw issuance, and with which device authentication can be performed, for example, a mobile terminal such as a smartphone)
APP: an application program (software) which is executed for corresponding with C^{(j)} when a tpw request is made
suKeyᵢ^{(j)}: a key shared by U (such as U_{M}) and Sᵢ^{(j})
cID^{(j)}: the control center machine ID assigned to C^{(j)}
sysIDᵢ^{(j)}: the service system ID assigned to Sᵢ^{(j)}
mIDᵢ^{(j)}: the master ID to Sᵢ^{(j)}, and information shared by C^{(j)} and Sᵢ^{(j)}, that differs from user to user
tReqPw^{(j)}: a password used for a request of tpw issuances
reqPw: the seed information for tReqPw^{(j)} (that is the first information a user has in mind)
uIDᵢ^{(j)}: a user ID for Sᵢ^{(j)} (that is the second information a user has in mind), which is shared by U and Sᵢ^{(j)}
aID^{(j)}: ID assigned to APP (As mentioned later, plural distinct aID^{(j)}s can be assigned to an identical APP in order to evade user-linkability.)
uListᵢ^{(j)}: a management list that Sᵢ^{(j)} stores (the list which keeps information on U)
aList^{(j)}: a first management list that C^{(j)} stores (the list which keeps information on U_{M} etc.)
sList^{(j)}: a second management list that C^{(j)} stores (the list which keeps information on Sᵢ^{(j)} etc.)
cList^{(j)}: a third management list that C^{(j)} stores (the list which keeps information on C^{(j)} etc.)
pList: a list that U_{M} stores (the list which keeps information on C^{(j)} and Sᵢ^{(j)} etc.)
tpwInfoᵢ^{(j)}: information accompanied by tpw which is determined by Sᵢ^{(j)} and which can include information on the use restriction of tpw (In the following embodiments, because tpw is a common 1-day password, every tpwInfoᵢ^{(j)} includes the expiration date “before 00:00 of the next day of the date of tpw issue” and the frequency of possible use “no limit” as its restriction.)
Ticket: an electronic permit for registration of U to C^{(j)}, which is issued by C^{(j)}
Passᵢ^{(j)}: an electronic permit for tpw issuance, which is issued by C^{(j)}

In the following embodiments, one user uses two terminals (or more). However, one user may as well use only one terminal, and in that case, the terminal such as U_{M} may as well play serve both the second user terminal and the first one.

Also, in the following description, no matter whether the number of C^{(j)} is one or more, the numbers of reqPw, APP or pList may be one, and reqPw, APP or pList may exist for each C^{(j)}. In the following description, the numbers of reqPw, APP and pList are all one regardless of the number of C^{(j)}.

Also, in the following description, whereas we often explain processes for the subject of a program such as APP, the subject of processes may be a processor because a decided process is performed appropriately using a storage unit (such as a memory) and/or an interface unit (such as a communication port) etc. according as a program is executed by a processor (such as a CPU (Central Processing Unit)). A process described for the subject of a program may be a process that a processor or an apparatus/system possessing the processor performs. A program may be installed to an apparatus such as a computer using a program source. A program source may be, for example, a program distribution server or a storage media that a computer can read. In the case that a program source is a program distribution server, the program distribution server includes a processor (such as a CPU) and a storage unit, and furthermore, the storage unit may store distribution programs and programs being distributed. And then, the processor of the program distribution server may distribute programs being distributed to other computers, according as that the processor of the program distribution server executes the distribution program.

### Embodiment 1

In the following, we describe Embodiment 1. In Embodiment 1, there is one control center machine (only the C⁽¹⁾)

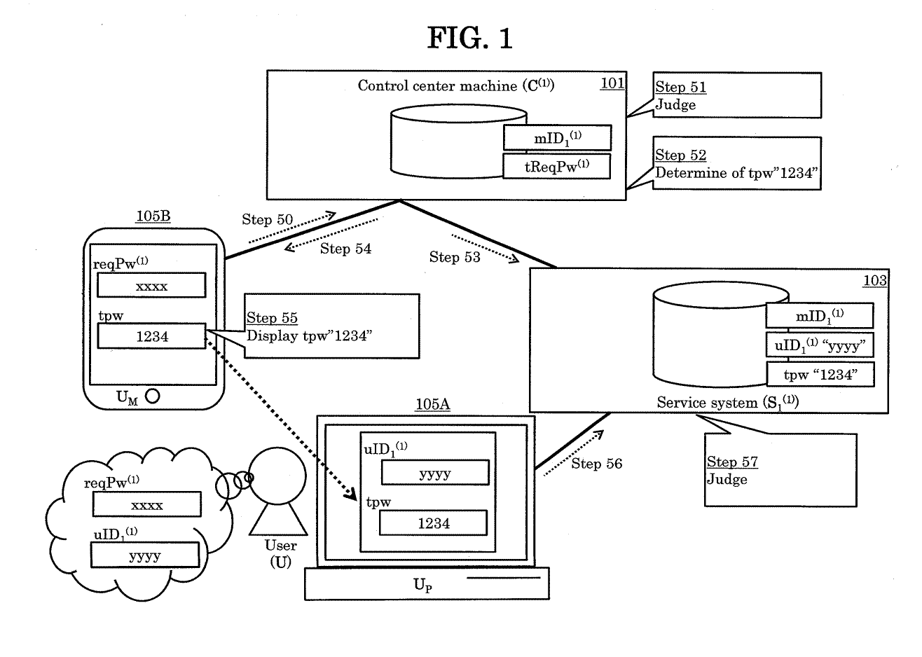

FIG. 1 shows the overview of the authentication process at Embodiment 1.

An authentication among three entities is executed, according as that a control center machine 101 (C⁽¹⁾) that issues tpw intervenes in the two entities, a service system 103 (In FIG. 1, illustrated is only Sᵢ⁽¹⁾) and a user terminal 105 (the first user terminal 105A (U_{P}), the second user terminal 105B (U_{M})).

A user (U) inputs a reqPw (for example, the value “xxxx”) at the display screen that is shown by APP executed in U_{M} the user possesses, and U_{M} (APP) generates tReqPw⁽¹⁾ based on the input reqPw, and sends a request of tpw issuance (Step 50). The request of tpw issuance is associated with (includes) the generated tReqPw⁽¹⁾ and Pass₁⁽¹⁾ that is issued by the C⁽¹⁾ in the pre-registration and that is stored in the U_{M}.

The C⁽¹⁾ receives the request of tpw issuance, and judges whether tReqPw⁽¹⁾ related to the request of tpw issuance coincides with the pre-registered tReqPw⁽¹⁾ or not, and whether Pass₁⁽¹⁾ related to the request of tpw issuance valid or not (Step 51). In the case where both judgements are positive, the C⁽¹⁾ determines a tpw (for example, the value “1234”), and issues the determined tpw to the U(U_{M}) and the S₁⁽¹⁾ (Steps 53 and 54). At that time, the C⁽¹⁾ sends, to the S₁⁽¹⁾, the information suite which includes mID₁⁽¹⁾ shared by S₁⁽¹⁾ and C⁽¹⁾, and the determined tpw (Step 53).

The U_{M} (APP) receives the tpw from the C⁽¹⁾, and outputs (or, displays) the received tpw (for example, the value “1234”) (Step 55). The output of tpw may be by means of other type output such as speech output, instead of or besides display.

The U (U_{P}) inputs, for S₁⁽¹⁾, the same tpw with the tpw in the information suite that U_{M} received, and uID₁⁽¹⁾ (for example, the value “yyyy”) that the U has in mind (Step 56).

The Sᵢ⁽¹⁾ identifies U corresponding to mID₁⁽¹⁾ received from the C⁽¹⁾. The S₁⁽¹⁾ judges whether the input uID₁⁽¹⁾ coincides with the pre-registered uID₁⁽¹⁾ or not, and whether the input tpw coincides with the tpw received from the C⁽¹⁾ (Step 57) or not. In the case where both judgements are positive, the S₁⁽¹⁾ provides service for the U.

There are three parameters (keys) given, for identifying the U, below:
tReqPw⁽¹⁾ shared by the C⁽¹⁾ and the U;
uID₁⁽¹⁾ shared by the S₁⁽¹⁾ and the U; and
mID₁⁽¹⁾ shared by the C⁽¹⁾ and the S₁⁽¹⁾.

The three IDs given above can be known only by two entities.

Namely,
The S₁⁽¹⁾ does not know the tReqPw⁽¹⁾;
The C⁽¹⁾ does not know the uID₁⁽¹⁾; and
The U does not know the mID₁⁽¹⁾.

Thus, by purposely making three-way deadlock, wherever data breach happens, unless any two entities leak data simultaneously, then impersonation crime cannot be materialized.

Since the U uses the U_{M} that the U possesses in order to get the tpw, no hardware for exclusive use is necessary. Also, as described later, the C⁽¹⁾ can recognize the U_{M} without U_{M}'s sending its individual identification number. In this embodiment, two-factor authentication with authentication by memories (user authentication being authentication for tReqPw⁽¹⁾ generated based on reqPw U has in mind) and authentication by possessions (device authentication being authentication of Pass₁⁽¹⁾ stored in U_{M} used at registration) can be performed.

In the following, explained are configuration examples of U_{M}, U_{P}, Sᵢ^{(j)} (S₁⁽¹⁾), C^{(j)} (C⁽¹⁾), uListᵢ^{(j)} (uList₁⁽¹⁾), aList^{(j)} (aList⁽¹⁾), pList, sList^{(j)} (sList⁽¹⁾) and cList^{(j)} (cList⁽¹⁾).

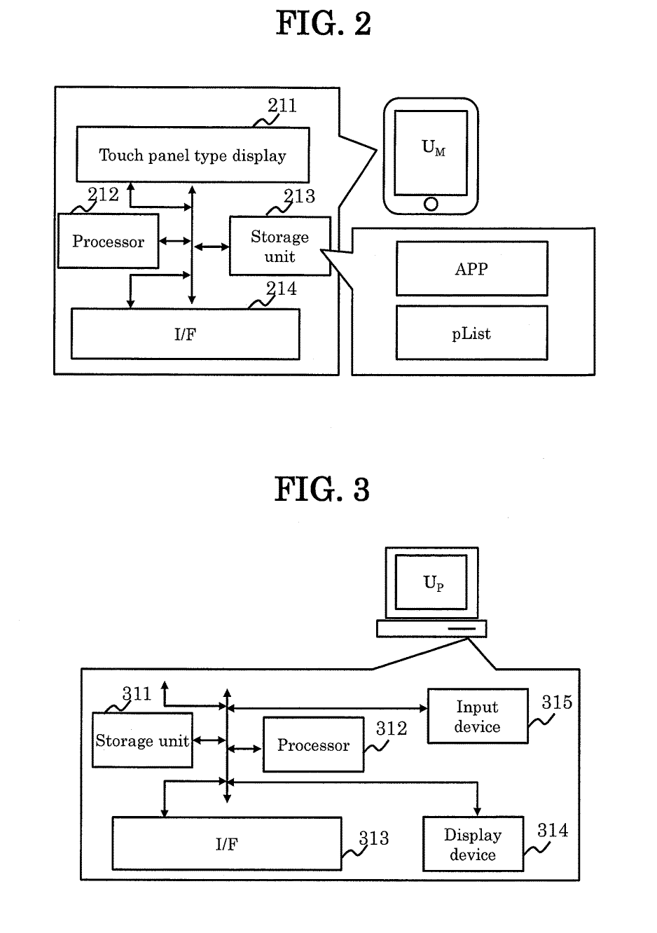

FIG. 2 shows a configuration example of the U_{M}.

The U_{M} is a mobile terminal such as a smartphone. A smartphone is a kind of smart devices. A smart device is a multifunctional device which is available for not only simple calculation but also wide variety of use, and typically is a smartphone or a tablet PC. The U_{M} comprises a touch panel type display 211, a storage unit 213, an I/F (communication interface device) 214, and a processor 212 that is coupled to those. The touch panel type display 211 is an example of an input device and a display device, and is a one-piece device with an input device and a display device. The storage unit 213 stores programs such as an APP and data such as a pList. The processor 212 executes the APP. The APP refers to or updates the pList, and communicates with an external apparatus such as C^{(j)} (the C⁽¹⁾) via the I/F 214, by turns. The APP may display at least a part of the pList on the touch panel type display 211, and may send (input) the received tpw to the U_{P} via a wireless LAN or the like.

FIG. 3 shows a configuration example of the U_{P}.

The U_{P} comprises a storage unit 311, an I/F 313, an input device 315, a display device 314 and a processor 312 that is coupled to those. The input device 315 is a device with which a user inputs data, and is, for example, a keyboard and a pointing device. The display device 314 is a device on which data is displayed, and is, for example, a liquid crystal display device. The storage unit 311 stores programs such as a web browser, and data. The processor 312, by executing a program such as the web browser, communicates with an external apparatus such as the Sᵢ^{(j)} (S₁⁽¹⁾) via the I/F 313.

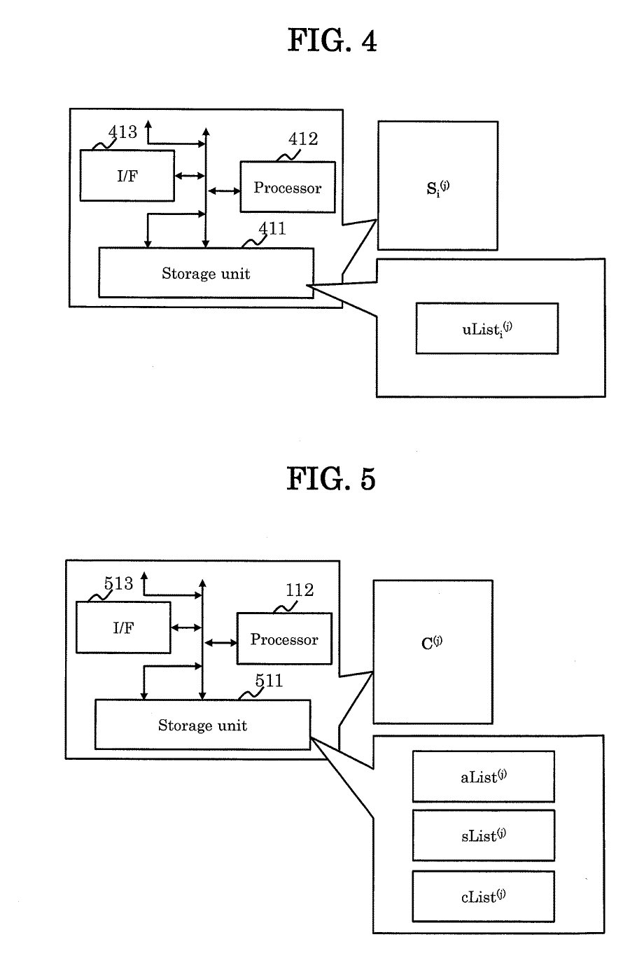

FIG. 4 shows a configuration example of the Sᵢ^{(j)} (S₁⁽¹⁾).

The Sᵢ^{(j)} (S₁⁽¹⁾) comprises a computer system that provides services to user terminals (for example, the U_{P}), and is typically a computer system of a service company. The Sᵢ^{(j)} (S₁⁽¹⁾) is one or more computers, and comprises a storage unit 411, an I/F 413, and a processor 412 that is coupled to those. The storage unit 411 stores programs and data such as a uListᵢ^{(j)} (uList₁⁽¹⁾). The processor 412, by executing the programs in the storage unit 411, refers to or updates the uListᵢ^{(j)} (uList₁⁽¹⁾), and communicates with an external apparatus such as the U_{P} via the I/F 413.

FIG. 5 shows a configuration example of the C^{(j)} (C⁽¹⁾).

The C^{(j)} (C⁽¹⁾) is a computer system that issues tpw. The C^{(j)} (C⁽¹⁾) is one or more computers, and comprises a storage unit 511, an I/F 513 and a processor 512 that is coupled to those. The storage unit 511 stores programs and data such as an aList^{(j)} (aList⁽¹⁾), a sList^{(j)} (sList⁽¹⁾) and a cList^{(j)} (cList⁽¹⁾). The processor 512, by executing the programs in the storage unit 511, refers to or updates the aList^{(j)} (aList⁽¹⁾), the sList^{(j)} (sList⁽¹⁾) and the cList^{(j)} (cList⁽¹⁾), and communicates with an external apparatus such as the U_{M} or the Sᵢ^{(j)} (S₁⁽¹⁾) via the I/F 513.

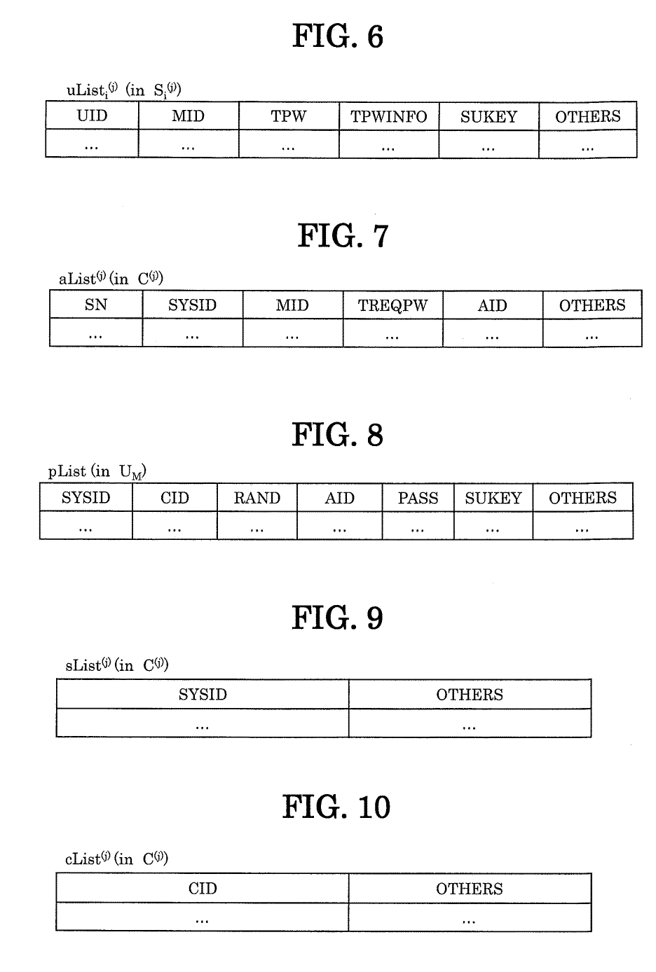

FIG. 6 shows a configuration example of the uListᵢ^{(j)} (uList₁⁽¹⁾). Here, in FIG. 6 to FIG. 10, the names of the information elements in the lists are written with capital letters. Also, in the following, we call a row (a record) in a list “account”.

The uListᵢ^{(j)} (uList₁⁽¹⁾) has data on U. The information elements that each account in the uListᵢ^{(j)} has, are, for example, UID, MID, TPW, TPWINFO, SUKEY and OTHERS. The UID indicates uIDᵢ^{(j)} registered. The MID indicates mIDᵢ^{(j)} registered. The TPW indicates tpw registered. The TPWINFO indicates tpwInfoᵢ^{(j)}. The SUKEY indicates suKeyᵢ^{(j)} registered. The OTHERS indicates other information elements, and may include the user name of U, for example.

FIG. 7 shows a configuration example of the aList^{(j)} (aList⁽¹⁾).

The aList^{(j)} (aList⁽¹⁾) has data on U_{M} etc. The information elements that each account in aListᵢ^{(j)} has, are, for example, SN, SYSID, MID, TREQPW, AID and OTHERS. The SN indicates serial numbers (sn) registered. The SYSID indicates sysIDᵢ^{(j)} registered. The MID indicates mIDᵢ^{(j)} registered. The TREQPW indicates tReqPw^{(j)} registered. The AID indicates aID^{(j)} registered. One aID^{(j)} is assigned to one APP and one C^{(j)}, but plural distinct aID^{(j)}s may be generated for one APP and one C^{(j)}. The OTHERS indicates other information elements, and may include information necessary for operation etc. by C^{(j)}, for example.

FIG. 8 shows a configuration example of the pList.

The pList (pList) has data on C^{(j)} and Sᵢ^{(j)} etc. The information elements that each account in pList has, are, for example, SYSID, CID, RAND, AID, PASS, SUKEY and OTHERS. The SYSID indicates sysIDᵢ^{(j)} registered. The CID indicates cID^{(j)} registered. The RAND indicates a random number registered (that we write as Rand hereafter). The Rand, as described later, is used in order to generate (figure out) tReqPw^{(j)}. The AID indicates aID^{(j)} registered. The PASS indicates Passᵢ^{(j)} registered. The Passᵢ^{(j)} is an electronic permit for tpw issuance. The details of Passᵢ^{(j)} are described later. The SUKEY indicates suKeyᵢ^{(j)} registered. The OTHERS indicates other information elements, and may include information on communication etc. with C^{(j)}, for example.

FIG. 7 shows a configuration example of the sList^{(j)} (sList⁽¹⁾).

The sList^{(j)} (sList⁽¹⁾) has data on Sᵢ^{(j)} etc. The information elements that each account in sList^{(j)} has, are, for example, SYSID and OTHERS. The SYSID indicates sysIDᵢ^{(j)} registered. The OTHERS indicates other information elements, and may include the name of Sᵢ^{(j)} and information necessary for communication with Sᵢ^{(j)} (such as FQDN (Fully Qualified Domain Name) and the network address), for example.

FIG. 10 shows a configuration example of the cList^{(j)} (cList⁽¹⁾).

The cList^{(j)} (cList⁽¹⁾) has data on other C^{(j)} etc. (In this embodiment, since the number of C^{(j)} is one, cList^{(j)} is blank.) The information elements that each account in cList^{(j)} has, are, for example, CID and OTHERS. The CID indicates cID^{(j)} registered. The OTHERS indicates other information elements, and may include the name of other C^{(j)} and information necessary for communication with other C^{(j)} (such as FQDN and the network address), for example.

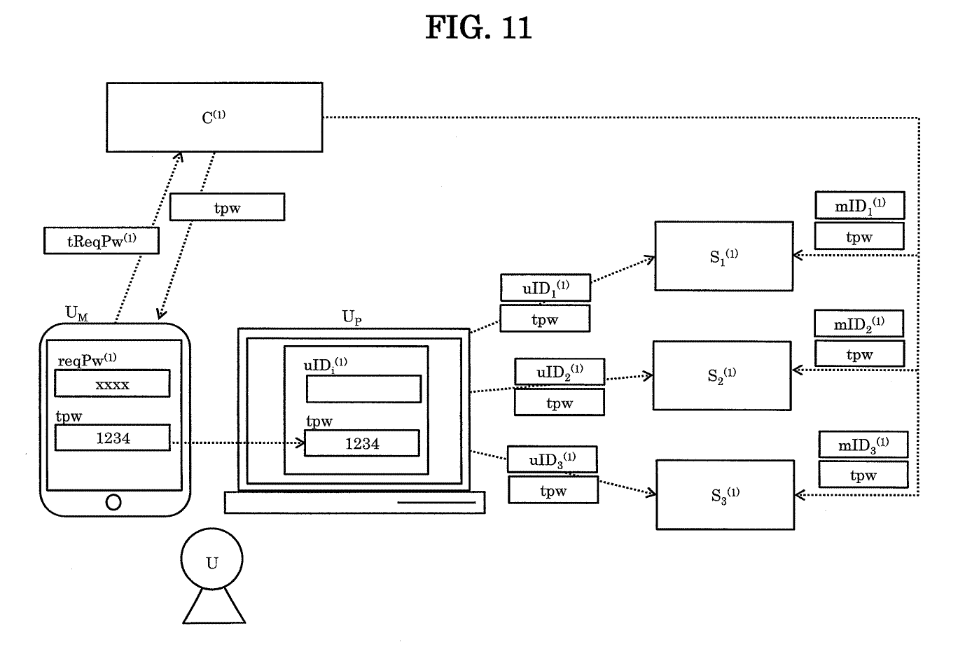

FIG. 11 shows tpw provision by the C⁽¹⁾.

The C⁽¹⁾ provides tpw (such as the value “1234”) (and mIDᵢ⁽¹⁾) to all Sᵢ⁽¹⁾ the user makes a contract with (respective Sᵢ⁽¹⁾ corresponding to sysIDᵢ^{(j)} identified by the aList⁽¹⁾ for the identified user). According to the example given by FIG. 11, the Sᵢ⁽¹⁾ which the user makes a contract with are S₁⁽¹⁾, S₂⁽¹⁾ and S₃⁽¹⁾. The C⁽¹⁾ may provide tpw to the Sᵢ⁽¹⁾ without tpw query by the Sᵢ⁽¹⁾, and may provide tpw to the Sᵢ⁽¹⁾ as the response for tpw query by the Sᵢ⁽¹⁾. The U (U_{P}) can login to any Sᵢ⁽¹⁾ which the U make a contract with, using the identical tpw, until the expiration date that tpwInfoᵢ⁽¹⁾ represents (for example, during the day (the valid period does not have to be for 24 hours, and the period of validity does not have to be until 23:59 on the day (that is, one example that means the time just before 0:00 on the next day))). The tpwInfoᵢ⁽¹⁾ may be distinct for each Sᵢ⁽¹⁾, and may be identical for plural Sᵢ⁽¹⁾.

In the following, we describe the flow of the process performed in this embodiment.

### <Pre-Registration>

### <<First Registration>>

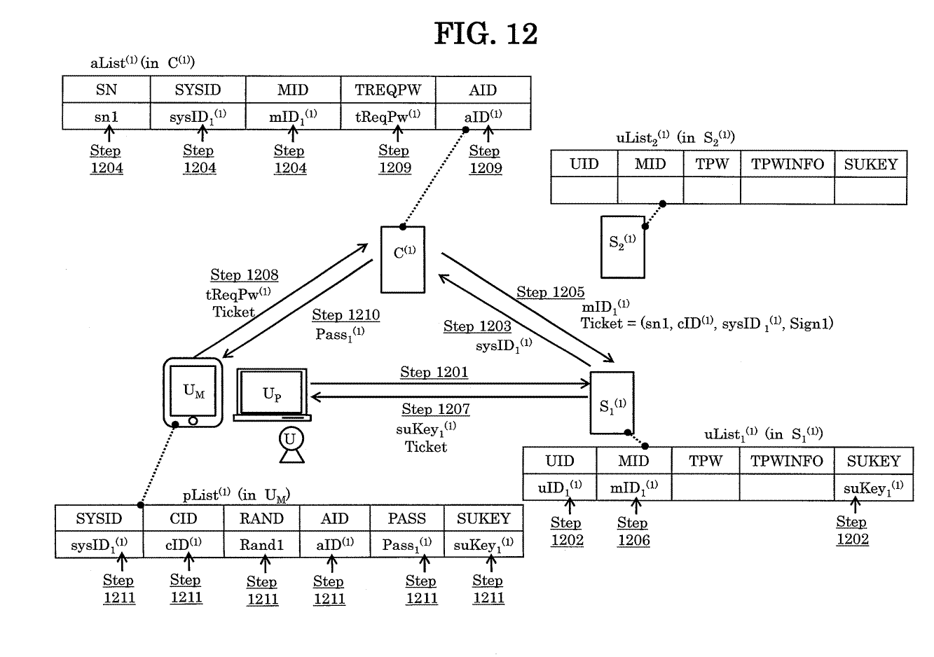

FIG. 12 shows an example of the flow for the first registration.

First registration is a pre-registration by which U that is not registered in C⁽¹⁾ becomes able to use Sᵢ⁽¹⁾. First registration includes a two-stage procedure. The first stage is a procedure performed between U and Sᵢ⁽¹⁾, and the second stage is a procedure performed between U and C⁽¹⁾.

The first stage (the procedure performed between U and Sᵢ⁽¹⁾) consists of Step 1201 to Step 1207 in the following. Here, we think that the U makes a usage application to the S₁⁽¹⁾.

(Step 1201) The U (U_{P}) sends the usage application to the S₁⁽¹⁾. At that time, the U (U_{P}) determines uID₁⁽¹⁾ used for the S₁⁽¹⁾.

(Step 1202) The S₁⁽¹⁾ receives the usage application from the U (U_{P}), determines suKey₁⁽¹⁾ for the U as the response for the application, and adds the account to uList₁⁽¹⁾. The S₁⁽¹⁾ registers, to the added account, the determined uID₁⁽¹⁾ as UID, and registers the determined suKey₁⁽¹⁾ as SUKEY.

(Step 1203) The S₁⁽¹⁾ sends, to C⁽¹⁾, a user addition request associated with sysID₁⁽¹⁾.

(Step 1204) The C⁽¹⁾ receives the user addition request, determines mID₁⁽¹⁾ corresponding to both sysID₁⁽¹⁾ and the added U, and adds the account to aList⁽¹⁾. The C⁽¹⁾ registers, to the added account, sn (such as the serial number for the accounts) as SN, sysID₁⁽¹⁾ related to the user addition request as SYSID, and the determined mID₁⁽¹⁾ as MID. Hereafter, we often write, as “sn1”, the sn determined here.

(Step 1205) The C⁽¹⁾ generates a registration ticket (hereafter, Ticket), and sends the generated Ticket and mID₁⁽¹⁾ determined in Step 1204, to the S₁⁽¹⁾. Ticket is based on the first digital signature (hereafter, “Sign1”), cID⁽¹⁾, the registered sn1 and sysID₁⁽¹⁾. Specifically, the Ticket includes Sign1, cID⁽¹⁾, sn1 and sysID₁⁽¹⁾ (Ticket=(sn1, cID⁽¹⁾, sysID₁⁽¹⁾, Sign1)). The Sign1 is based on the cID⁽¹⁾, the registered sn1 and sysID₁⁽¹⁾. Here, in the Ticket, the sn is the information element that the C⁽¹⁾ uses in order to identify the user (the serial number, for example). The cID^{(j)} is the information element that the APP uses in order to identify to which control center machine to register (In some way such as that cID^{(j)} includes the information necessary for communication with C^{(j)}, the information necessary for communication with C^{(j)} and cID^{(j)} have only to be associated with each other in APP). The Ticket does not have to include sysID₁⁽¹⁾. For example, the Sign1 includes the cID⁽¹⁾, the sn1 and the sysID₁⁽¹⁾ (Sign1=sign(sn1, cID⁽¹⁾, sysID₁⁽¹⁾, aux)). If the sysID₁⁽¹⁾ is not included in the Ticket, then the sysID₁⁽¹⁾ does not have to be included in the Sign1. The Sign1 has only to be verified by C⁽¹⁾ for its validity. Here, aux (auxiliary information) may include some information elements in the uList₁⁽¹⁾ (for example, at least a part of the OTHERS). The aux does not have to be included in the Sign1.

(Step 1206) The S₁⁽¹⁾ receives the Ticket and the mID₁⁽¹⁾ from the C⁽¹⁾. The S₁⁽¹⁾ associates the uID₁⁽¹⁾ registered at Step 1202 with the received mID₁⁽¹⁾. Specifically, the S₁⁽¹⁾ registers, as MID, the received mID₁⁽¹⁾ to the account with the uID₁⁽¹⁾ registered at Step 1202.

(Step 1207) The S₁⁽¹⁾ sends, to the U (U_{P}), the received Ticket and the suKey₁⁽¹⁾ registered at Step 1202.

The second stage (the procedure performed between U and C⁽¹⁾) consists of Steps 1208 to 1211 in the following.

(Step 1208) The U determines reqPw, and inputs, to the U_{M}, the determined reqPw, and the Ticket and the suKey₁⁽¹⁾ that are received with U_{P}. The APP in the U_{M}, in response to that input, determines a random number (Rand), and generates tReqPw⁽¹⁾. The tReqPw⁽¹⁾ is based on the determined Rand and the input reqPw (Hereafter, we often write, as “Rand1”, the Rand determined here). Specifically, for example, the tReqPw⁽¹⁾ is the irreversibly converted value of reqPw using a collision-resistant one-way function (hash function) and the Rand1 (tReqPw^{(j)}=hⱼ(Rand1, reqPw)). Whereas the tReqPw^{(j)} plays a role of passwords, since it is something indecipherably encrypted by a collision-resistant one-way function etc., the secrecy of reqPw can be kept. The function h for generation of tReqPw, as the notation of hⱼ, may be distinct for each control center machine. Therefore the U, only with having one reqPw in mind, can register the tReqPw distinct for each control center machine. The U_{M} (APP) sends the Ticket and the tReqPw⁽¹⁾ to the C⁽¹⁾ identified by the cID⁽¹⁾ in the Ticket. Here, whereas the confidentiality may be decreased, it is possible that the U_{M} sends the Rand and the reqPw to the C⁽¹⁾, and the C⁽¹⁾ generates the tReqPw⁽¹⁾ using the Rand and the reqPw sent by the U_{M}. Also, the Rand does not have to be, but, with Rand, it can be avoided that all tReqPw⁽¹⁾ for the identical U in the aList⁽¹⁾ in the C⁽¹⁾ are of the same value.

(Step 1209) The C⁽¹⁾ receives the Ticket and the tReqPw⁽¹⁾ from the U_{M} (APP). The C⁽¹⁾ judges whether the Ticket is valid or not by judging whether the Sign1 in the Ticket is correct or not. In the case where the judgement is positive, the C⁽¹⁾ identifies the account in the aList⁽¹⁾ that has SN coinciding with the sn in the Ticket. The C⁽¹⁾ generates aID⁽¹⁾ for the APP (U_{M}) that is the sender of Ticket, registers the generated aID⁽¹⁾ as AID, and registers the received tReqPw⁽¹⁾ as TREQPW for the identified account. Whereas tReqPw^{(j)} plays a role of passwords, since it is something indecipherably encrypted by a collision-resistant one-way function etc., the secrecy of reqPw can be kept even if tReqPw^{(j)} is leaked from aList⁽¹⁾.

(Step 1210) The C⁽¹⁾ generates Pass₁⁽¹⁾, and sends the generated Pass₁⁽¹⁾ to the U_{M} (APP). The Pass₁⁽¹⁾ is based on the sn1, the cID⁽¹⁾ and the sysID₁⁽¹⁾ that are already registered in the aList⁽¹⁾, the aID⁽¹⁾ registered at Step 1209, and the second digital signature (hereafter, “Sign2”). Specifically, for example, the Pass₁⁽¹⁾ includes the sn1, the cID⁽¹⁾, the sysID₁⁽¹⁾, the aID⁽¹⁾ and the Sign2 (Pass₁⁽¹⁾=(sn1, cID⁽¹⁾, sysID₁⁽¹⁾, aID⁽¹⁾, Sign2)). The aID⁽¹⁾ in Pass₁⁽¹⁾ is the information element used for identifying all (or some) Sᵢ⁽¹⁾ that are the issue destinations of tpw when receiving a request of tpw issuance from the U_{M} later (In the aList⁽¹⁾, an identical aID⁽¹⁾ is associated with to plural sysIDᵢ⁽¹⁾). Sign2 is based on sn1, cID⁽¹⁾, sysID₁⁽¹⁾ and aID⁽¹⁾ that is registered at Step 1209. Specifically, for example, the Sign2 includes the sn1, the cID⁽¹⁾, the sysID₁⁽¹⁾ and the aID⁽¹⁾ (Sign2=sign(sn1, cID⁽¹⁾, sysID₁⁽¹⁾, aID⁽¹⁾, aux)).

(Step 1211) The U_{M} (APP) receives the Pass₁⁽¹⁾ from C⁽¹⁾, and adds an account in the pList. The U_{M} (APP), to the added account, registers the sysID₁⁽¹⁾ in the Pass₁⁽¹⁾ (or in the Ticket) as SYSID, the cID⁽¹⁾ in the Pass₁⁽¹⁾ (or in the Ticket) as CID, the Rand1 determined at Step 1208 as RAND, the aID⁽¹⁾ in Pass₁⁽¹⁾ as AID, the received Pass₁⁽¹⁾ as PASS, and the suKey₁⁽¹⁾ input at Step 1208 as SUKEY. Here, among the information elements registered in an account in the pList, information elements, for example, except for the cID⁽¹⁾ and sysID₁⁽¹⁾, may be encrypted using at least one of the data U_{M} has (for example, at least one of the individual identification data and the personal identity number in the future (and its accompanying data)) and the data the U has in mind (for example, reqPw), as the encryption key (Since cID⁽¹⁾ and sysID₁⁽¹⁾ are open information elements, they do not have to be encrypted).

### <<Second or Further Registration>>

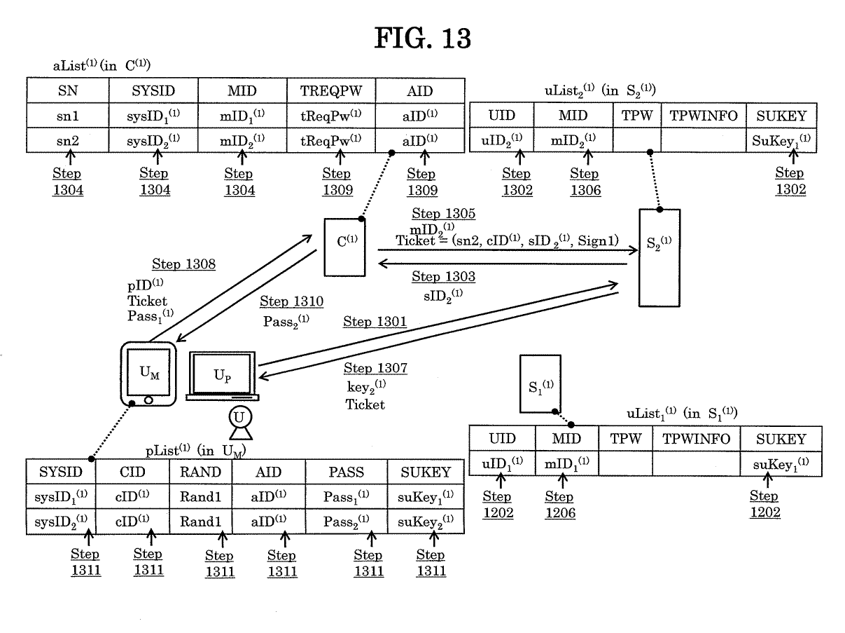

FIG. 13 shows an example of the flow for Second or further registration.

When the U that is already registered in the C⁽¹⁾ make a use of another service system (say, S₂⁽¹⁾), the U can use the aID⁽¹⁾ received at the First registration. Specifically, the first stage is the same with that for First registration (Steps 1301 to 1307 are the same with Steps 1201 to 1207, respectively). The second stage (the procedure performed between the U and the C⁽¹⁾) is in the following. Mainly, we describe the difference from the second stage in the First registration, and omit or simplify the description for similarities with the second stage in First registration.

(Step 1308) The U inputs, to the U_{M}, the reqPw that the U has used at the First registration (data that the U has in mind) and the Ticket and suKey₂⁽¹⁾ that are received with the U_{P}. The U_{M} (APP) displays the pList to the touch panel type display 211, and receives, from the U, the choice of the accounts now used. The U_{M} (APP) judges whether the cID⁽¹⁾ in the input Ticket is the same with the cID⁽¹⁾ obtained from the chosen account, or not. In the case where this judgement is positive, the U_{M} (APP) generates tReqPw⁽¹⁾ (=h₁(the obtained Rand1, the input reqPw)), and sends the generated tReqPw⁽¹⁾, Pass₁⁽¹⁾ obtained from the account, and the input Ticket, to the C⁽¹⁾.

(Step 1309) The C⁽¹⁾ receives the Ticket, the Pass₁⁽¹⁾ and the tReqPw⁽¹⁾ from the U_{M} (APP). The C⁽¹⁾, by verifying the Sign1 in the received Ticket, judges whether the Ticket is valid or not. In the case where the judgement is positive, the C⁽¹⁾ identifies the account in the aList⁽¹⁾ that has SN coinciding with the sn (hereafter, “sn2”) in the Ticket, and also retrieves the aID⁽¹⁾ from the received Pass₁⁽¹⁾. The C⁽¹⁾ registers, to the identified account, sn2 in the Ticket as SN, the retrieved aID⁽¹⁾ as AID, and the received tReqPw⁽¹⁾ as TREQPW.

(Step 1310) The C⁽¹⁾ generates Pass₂⁽¹⁾ (=(sn2, cID⁽¹⁾, sysID₂⁽¹⁾, aID⁽¹⁾, Sign2)), and sends the generated the Pass₂⁽¹⁾ to the U_{M} (APP). The Sign2 in the Pass₂⁽¹⁾ is Sign2=sign(sn2, cID⁽¹⁾, sysID₂⁽¹⁾, aID⁽¹⁾, aux).

(Step 1311) U_{M} (APP) receives the Pass₂⁽¹⁾ from the C⁽¹⁾, and adds an account in the pList. The U_{M} (APP), to the added account, registers the sysID₂⁽¹⁾ in Pass₂⁽¹⁾ (or in the Ticket) as SYSID, the cID⁽¹⁾ in the Pass₂⁽¹⁾ (or in the Ticket) (or cID⁽¹⁾ obtained at Step 1308) as CID, the Rand1 obtained at Step 1308 as RAND, the Pass₂⁽¹⁾ as PASS, and the suKey₂⁽¹⁾ input at Step 1308 as SUKEY.

As described above, Pre-registration consists of First registration and Second or further registration. The U may clarify, to the U_{M} (APP), which of the First registration and the Second or further registration it is. For example, the APP displays the screen that receives the choice that is either First registration or the Second or further registration (such as GUI (Graphical User Interface) with the button for First registration and the button for the Second or further registration), and, according to which button is pushed, may determine to execute which process of the First registration and the Second or further registration. Also, the U may choose the First registration in the case where the U uses some Sᵢ⁽¹⁾ first time after the First registration for the C⁽¹⁾ has been finished. In this case, it turns out that, for an identical U, plural distinct aID⁽¹⁾ are registered in the C⁽¹⁾. Whether it is the First registration or the Second or further registration, is whether an identical aID⁽¹⁾ is associated with plural distinct Sᵢ⁽¹⁾ or not. If the association is performed, then the restoration is relatively easy in case the U_{M} is lost or reqPw is forgotten, and so on. Because, if the U tells, to some Sᵢ⁽¹⁾, the effect, then the Sᵢ⁽¹⁾ can send mIDᵢ⁽¹⁾ corresponding to the U to the C⁽¹⁾, and the C⁽¹⁾ can identify aID⁽¹⁾ associating with the mIDᵢ⁽¹⁾, and can identify, with the aList⁽¹⁾, all sysIDᵢ⁽¹⁾ associating with the identified aID⁽¹⁾. Also, for the U, since an identical aID⁽¹⁾ associates with plural distinct sysIDᵢ⁽¹⁾, the group of Sᵢ⁽¹⁾ for the U can be identified. On the other hand, if the association is not performed, then it can be avoided that the C⁽¹⁾ may identify, with the aList⁽¹⁾, which plural Sᵢ⁽¹⁾ the U uses. In Embodiment 1, the U can choose whether the association is performed or not.

### <Issuance of Tpw (Common 1-Day Password)>

In the following, we describe the flow for the issuance of tpw that can be available for all or some Sᵢ⁽¹⁾ the U registers to use.

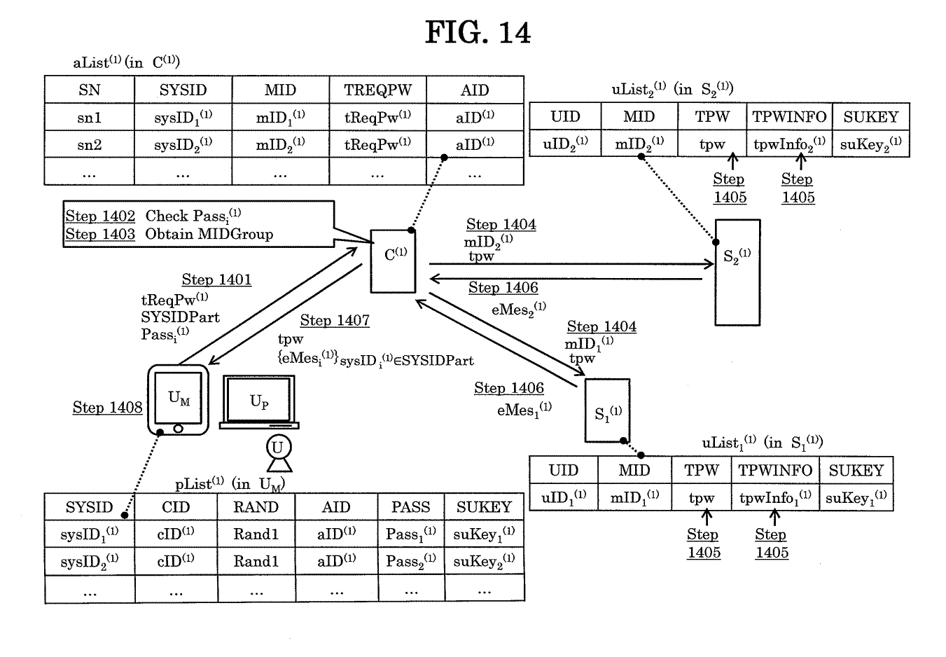

FIG. 14 shows an example of the flow for the issuance of tpw at Embodiment 1. Here, in the following description, the group of plural SYSID (here, all SYSID registered in pList) is denoted by “SYSIDGroup”. Also, at least one of SYSID is denoted by “SYSIDPart”. Hence, SYSIDPart satisfies SYSIDPart⊂SYSIDGroup (“SYSIDPart⊂SYSIDGroup” includes the case of SYSIDPart=SYSIDGroup). And, Pass_{SYSIDPart} for SYSIDPart⊂SYSIDGroup is {Passᵢ⁽¹⁾}_{K}. K stands for sysIDᵢ⁽¹⁾εSYSIDPart. That is, the meaning of Pass_{SYSIDPart} is the set of Passᵢ⁽¹⁾ each of which is corresponding to the respective sysIDᵢ⁽¹⁾ constructing SYSIDPart. The flow of the issuance for tpw that U can use for all in SYSIDPart C SYSIDGroup, is in the following.

(Step 1401) The U_{M} (APP) displays, for example, at least a part of data in the pList, and receives, from the U, the choice of SYSIDPart among SYSIDGroup and the input of reqPw. U_{M} (APP) chooses one Passᵢ⁽¹⁾ from Pass_{SYSIDPart}. Also, the U_{M} (APP) obtains Rand from the account with the chosen Passᵢ⁽¹⁾, and generates tReqPw⁽¹⁾ using the obtained Rand and the input reqPw. The U_{M} (APP) sends a request of tpw issuance associated with SYSIDPart chosen by the U, the generated tReqPw⁽¹⁾ and the chosen Passᵢ⁽¹⁾, to the C⁽¹⁾ identified by the cID⁽¹⁾ corresponding to the chosen Passᵢ⁽¹⁾. Here, the choice of SYSIDPart may be performed by the U_{M} (APP) instead of the U.

(Step 1402) The C⁽¹⁾ receives the request of tpw issuance from the U_{M} (APP), and performs the first judgement of whether the tReqPw⁽¹⁾ related to the request is correct or not, and the second judgement of whether Passᵢ⁽¹⁾ related to the request is valid or not. The first judgement is, for example, the judgement of whether TREQPW for the account (an account in aList⁽¹⁾) with sn coinciding with the sn in the Passᵢ⁽¹⁾ coincides with the tReqPw⁽¹⁾ related to the request, or not. The second judgement is performed by judging whether Sign2 in the Passᵢ⁽¹⁾ is correct or not, using the information elements (CID, SYSID, AID) for the account (an account in aList⁽¹⁾) with the sn coinciding with sn in Passᵢ⁽¹⁾ and the information elements (cID⁽¹⁾, sysIDᵢ⁽¹⁾, aID⁽¹⁾) in the Passᵢ⁽¹⁾. In the case where at least one of the first judgement and the second judgement is negative, the C⁽¹⁾ may stop the process. In the case where both of the first judgement and the second judgement are positive, the C⁽¹⁾ performs Step 1403.

(Step 1403) The C⁽¹⁾ refers to the aList⁽¹⁾, and identifies all the accounts that have AID coinciding with the aID⁽¹⁾ in the Passᵢ⁽¹⁾ judged to be valid, and that have SYSID coinciding with some sysIDᵢ⁽¹⁾ in SYSIDPart related to the request of tpw issuance. The C⁽¹⁾ obtains the respective MID (mIDᵢ⁽¹⁾) from all the identified accounts. The set of mIDᵢ⁽¹⁾ obtained here, is denoted by “MIDGroup”. MIDGroup is {mIDᵢ⁽¹⁾}_{L}. L stands for “sysIDᵢ⁽¹⁾ εSYSIDPart, AID=aID⁽¹⁾”.

(Step 1404) The C⁽¹⁾ determines tpw. The tpw may be, for example, a random value. The C⁽¹⁾, for each sysIDᵢ⁽¹⁾ (εSYSIDPart), performs the following. In the description for Steps from 1404 to 1407, one sysIDᵢ⁽¹⁾ is taken as an example. The C⁽¹⁾ sends, to Sᵢ⁽¹⁾ corresponding to sysIDᵢ⁽¹⁾, mIDᵢ⁽¹⁾ corresponding to the Sᵢ⁽¹⁾ and the determined tpw (the C⁽¹⁾ sends a request of tpw registration associated with the mIDᵢ⁽¹⁾ and the tpw, to the Sᵢ⁽¹⁾). Here, the C⁽¹⁾ sends tpw without query from the Sᵢ⁽¹⁾, but, as described above, the C⁽¹⁾ may send tpw as a response for the query.

(Step 1405) The Sᵢ⁽¹⁾ receives the mIDᵢ⁽¹⁾ corresponded to the Sᵢ⁽¹⁾ and the determined tpw, from the C⁽¹⁾. The Sᵢ⁽¹⁾ identifies the account in the uListᵢ⁽¹⁾ that has MID coinciding with the received mIDᵢ⁽¹⁾. The Sᵢ⁽¹⁾ registers, to the identified account, the received tpw as TPW. Also, the Sᵢ⁽¹⁾ determines tpwInfoᵢ⁽¹⁾ for the tpw, and registers, to the account, the determined tpwInfoᵢ⁽¹⁾ as TPWINFO. The tpwInfoᵢ⁽¹⁾ may include information that represents the restriction on tpw such as the expiration date of the tpw and the frequency of possible use. In this embodiment, as described above, since the tpw means a common 1-day password, tpwInfoᵢ⁽¹⁾ includes, as the use restriction, the expiration of date “before 00:00 of the next day of the date of tpw issue” and the frequency of possible use “no limit”.

(Step 1406) The Sᵢ⁽¹⁾ obtains SUKEY (suKeyᵢ⁽¹⁾) for the account identified at Step 1405. The Sᵢ⁽¹⁾ encrypts, with the obtained suKeyᵢ⁽¹⁾, data mesᵢ^{(j)} (mesᵢ⁽¹⁾) including the registered tpwInfoᵢ⁽¹⁾. As a result, eMesᵢ⁽¹⁾ (the encrypted data for mesᵢ⁽¹⁾) that is Enc_{SUKEY} (mesᵢ⁽¹⁾), is obtained (SUKEY=suKeyᵢ⁽¹⁾). The Sᵢ⁽¹⁾ sends the obtained eMesᵢ⁽¹⁾ to the C⁽¹⁾. Here, mesᵢ⁽¹⁾ may include information on Sᵢ⁽¹⁾ besides tpwInfoᵢ⁽¹⁾. The information on the Sᵢ⁽¹⁾ may include uIDᵢ⁽¹⁾ for the U (UID obtained from the account identified at Step 1405). The encryption function (Enc) may be, for example, the encryption function for a pre-determined symmetric encryption scheme. The eMesᵢ⁽¹⁾, as described later, is a data that reaches U_{M} (APP) via C⁽¹⁾. And, the eMesᵢ⁽¹⁾ is, by the U_{M} (APP), decrypted with the identical suKeyᵢ⁽¹⁾ with the suKeyᵢ⁽¹⁾ used for the encryption. That means that the mesᵢ⁽¹⁾ is obtained. The U_{M} (APP) displays at least a part of the data in the obtained mesᵢ⁽¹⁾ (for example, uIDᵢ⁽¹⁾) to the touch panel type display 211. Therefore, even if the U has forgotten uIDᵢ⁽¹⁾, the U can know uIDᵢ⁽¹⁾ in appropriate timing of the response for a request of tpw issuance (without U_{M}'s (APP's) bothering to make a query for uIDᵢ⁽¹⁾).

(Step 1407) In the case where the C⁽¹⁾ receives the responses (eMesᵢ⁽¹⁾) from all the Sᵢ⁽¹⁾ corresponding to sysIDᵢ⁽¹⁾ (εSYSIDPart), C⁽¹⁾ sends all of those eMesᵢ⁽¹⁾ (={eMesᵢ⁽¹⁾}_{M}), and the tpw determined at Step 1404, to U_{M} (APP) (M=sysIDᵢ⁽¹⁾εSYSIDPart).

(Step 1408) The U_{M} (APP) receives {eMesᵢ⁽¹⁾}_{M} and tpw from the C⁽¹⁾. The U_{M} (APP) performs the following for each eMesᵢ⁽¹⁾ included in {eMesᵢ⁽¹⁾}_{M}. One eMesᵢ⁽¹⁾ is taken as an example. The U_{M} (APP) identifies the account corresponding to the eMesᵢ⁽¹⁾ from the pList. The U_{M} (APP) obtains SUKEY (suKeyᵢ⁽¹⁾) from the identified account, and decrypts eMesᵢ⁽¹⁾ using the obtained suKeyᵢ⁽¹⁾. Therefore, the mesᵢ⁽¹⁾ is obtained. The U_{M} (APP), for at least a part of the information elements in the obtained mesᵢ⁽¹⁾, performs at least one of displaying it and registering it to the account identified above. The U_{M} (APP) may register the received tpw to the account. U_{M} (APP) may display the received tpw to Touch panel type display 211.

<Use of Sᵢ⁽¹⁾>

The flow is similar with the flow described with referring to FIG. 1. Specifically, it is, for example, the following. In the following, one Sᵢ⁽¹⁾ is taken as an example (Here, at the use phase of Sᵢ⁽¹⁾, the tpw provided for the U is already registered in the uListᵢ⁽¹⁾ the Sᵢ⁽¹⁾ has). The U inputs uIDᵢ⁽¹⁾ and tpw to the U_{P}. The Sᵢ⁽¹⁾ receives a service provision request from the U (U_{P}). The service provision request is associated with the uIDᵢ⁽¹⁾ and tpw that are input to the U_{P}. The Sᵢ⁽¹⁾ performs the collation for the uIDᵢ⁽¹⁾ and tpw. Specifically, the Sᵢ⁽¹⁾ judges whether there is an account to which UID and TPW coinciding with the uIDᵢ⁽¹⁾ and the tpw respectively are registered, or not. In the case where the judgement is positive, the Sᵢ⁽¹⁾ provides services for the U (U_{P}) (For example, Sᵢ⁽¹⁾ permits the login).

The identical tpw can be available to the plural Sᵢ⁽¹⁾ during the day (The expiration date the tpw for Sᵢ⁽¹⁾ is according to tpwInfoᵢ⁽¹⁾ that is corresponding to Sᵢ⁽¹⁾ and related to the tpw). Here, the expiration date of the tpw (the expiration date that tpwInfoᵢ⁽¹⁾ related to the tpw represents) does not have to be necessarily for 24 hours and to be until 23:59 on the day. Also, besides the expiration date, the frequency of possible use (N times (N is an arbitrary integer greater then or equal to 1)) may be defined as the restriction for tpw. The tpwInfoᵢ⁽¹⁾ may be distinct for each Sᵢ⁽¹⁾.

Also, the U_{M} (APP) may display all (or a part) of the uIDᵢ⁽¹⁾ used at that respective Sᵢ⁽¹⁾ the U uses. For example, the U_{M} (APP) may issue a query to the C⁽¹⁾ for user ID as the response for a request from the U. The flow from the query for the user ID to its response, may be similar with the flow from the query of a request of tpw issuance to its response. In the response, the encrypted user ID (the uIDᵢ⁽¹⁾ encrypted with suKeyᵢ⁽¹⁾) coming from the Sᵢ⁽¹⁾ via the C⁽¹⁾ may be included. Also, in the response, one or more encrypted user ID corresponding to each of all (or a part) Sᵢ⁽¹⁾. The U_{M} (APP) may decrypt the encrypted user ID with suKeyᵢ⁽¹⁾, and display the decrypted user ID.

Also, for at least one Sᵢ⁽¹⁾, instead of sending tpw without the query from Sᵢ⁽¹⁾, the C⁽¹⁾ itself may keep it (For example, the C⁽¹⁾ may register the tpw to the account corresponding to the Sᵢ⁽¹⁾ (an account in the aList⁽¹⁾)). In this case, when the Sᵢ⁽¹⁾ receives a service provision request from the U (U_{P}), the Sᵢ⁽¹⁾ may send the tpw query associated with mIDᵢ⁽¹⁾ for the U. The C⁽¹⁾, when receiving the tpw query, may identify the tpw for mIDᵢ⁽¹⁾ corresponding to the tpw query, and may send the identified tpw to the Sᵢ⁽¹⁾ the tpw query origin.

Thus, according to Embodiment 1, at least one effect of the following can be successful.

(1) U is relieved from trouble of the management of ID and passwords. If the U obtains a tpw (common 1-day password) once a day, then the U can log in to all (or a part) of Sᵢ⁽¹⁾ the U uses, with the identical tpw during the day. Therefore, the U is relieved from trouble of the management. Also, even if uIDᵢ⁽¹⁾ is forgotten, it is displayed to the U_{M}. This respect contributes the release from trouble of the management.

(2) Security is enhanced.

tpw gets unavailable in one day (after the expiration date represented by tpwInfoᵢ⁽¹⁾). Therefore, even if the tpw is stolen, the tpw is not available on the next day. Hence, the security is enhanced. Also, by restricting the frequency of possible use besides the expiration date, further security enhancement can be expected. Also, the tpw cannot be obtained using any user terminals except for U_{M} used at Pre-registration. Because, in a user terminal except for the U_{M}, there does not exist the pList in which the information elements obtained at Pre-registration are registered. This respect also contributes the enhancement of security. Also, even if U_{M} is picked up by other people, since the reqPw that U has in mind is necessary for a request of tpw issuance, it cannot happen that the tpw is obtained by other people unless reqPw is known to other people.

(3) It is tolerant to information leakage.

The U does not know mIDᵢ⁽¹⁾ shared by the C⁽¹⁾ and the Sᵢ⁽¹⁾. The C⁽¹⁾ does not know uIDᵢ⁽¹⁾ shared by the Sᵢ⁽¹⁾ and the U. The Sᵢ⁽¹⁾ does not know tReqPw⁽¹⁾ shared by the C⁽¹⁾ and the U. Thus, by intentional three-way deadlock, even if information leakage happens at any one of the three entities, impersonation is not materialized.

(4) The growth for use of Sᵢ⁽¹⁾ can be expected.

For the U, use of service in the Internet begins with checking the ID and the password. The more the number of the service used, the more troublesome the management of ID and passwords is. By being relieved from such inconvenience, users are expected to expand use of the Internet more.

### Embodiment 2

In the following, we describe Embodiment 2. Then, we mainly describe the difference from Embodiment 1, and omit or simplify the description for similarities with Embodiment 1.

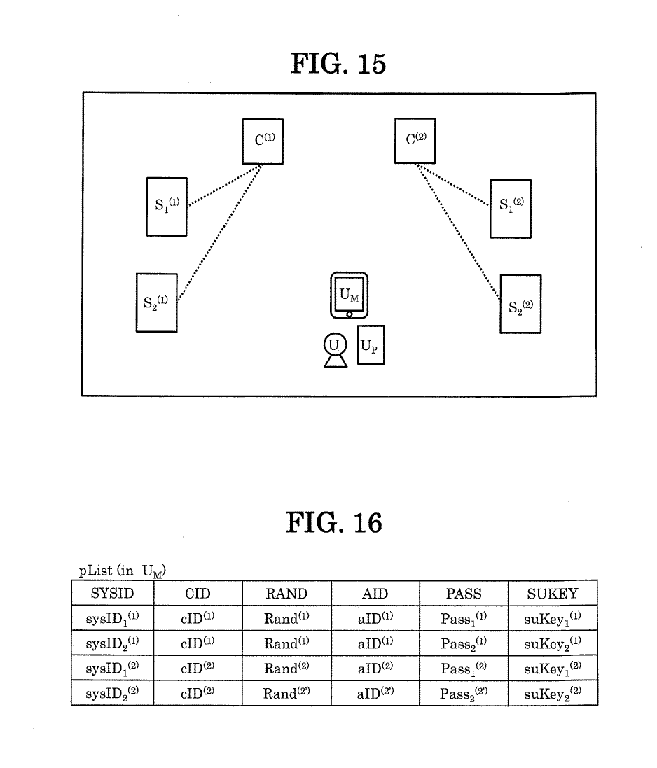

In Embodiment 2, there are two or more C^{(j)}. For example, as shown in FIG. 15, we suppose that C⁽¹⁾ and C⁽²⁾ exist. Also, we suppose that S₁⁽¹⁾ and S₂⁽¹⁾ are registered to the C⁽¹⁾, and that S₁⁽²⁾ and S₂⁽²⁾ are registered to the C⁽²⁾. And, we suppose that U is registered to those four service systems (the S₁⁽¹⁾, S₂⁽¹⁾, S₂⁽¹⁾ and S₂⁽²⁾). At that time, we suppose that the U, at the registration to the S₂⁽¹⁾, uses the data registered in the pList at the registration to the S₁⁽¹⁾, but the U, at the registration to the S₂⁽²⁾, does not use the data registered in the pList at the registration to the S₁⁽²⁾. In other words, we suppose that the First registration is performed for the S₁⁽¹⁾, and that the Second or further registration is performed for the S₂⁽¹⁾. Also, we suppose that the First registration is performed for the S₁⁽²⁾ and for the S₂⁽²⁾, too. If AID is of the same value, then RAND is also of the same value. Also, if AID is of the same value, then CID is also of the same value.

Consequently, the pList is as shown in FIG. 16. That means, AID associated with the S₂⁽¹⁾ is aID⁽¹⁾, that is, of the same with AID associated with the S₁⁽¹⁾. On the other hand, AID associated with the S₂⁽²⁾ is aID^{(2′)}, that is, different from AID associated with the S₂⁽¹⁾. In the case where there are two or more C^{(j)}, it is guessable that the U_{M} (APP) performs the flow for tpw issuance at Embodiment 1 for every C^{(j)}. However, then, tpw should be distinct for each C^{(j)}, and the convenience for the U is decreased.

Then, in Embodiment 2, tpw can be common for two or more C^{(j)}.

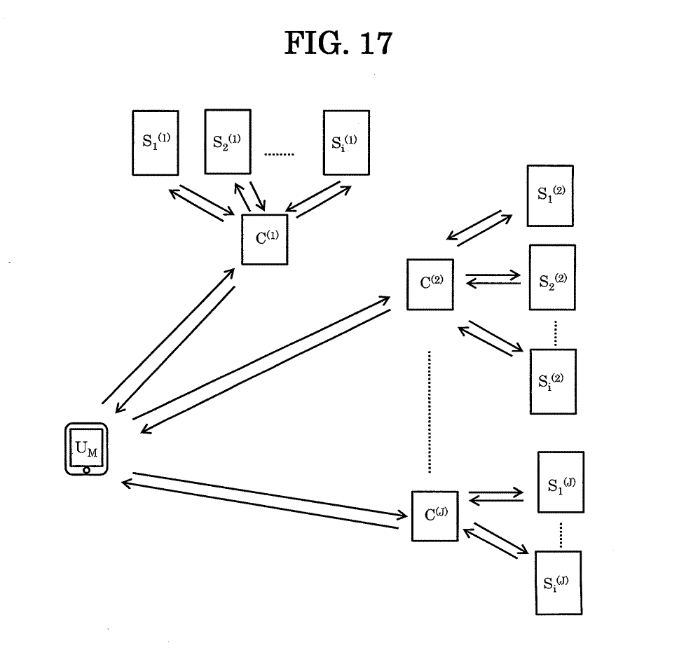

FIG. 17 shows an example of the flow for tpw issuance at Embodiment 2.

Between the U_{M} (APP) and the C⁽¹⁾ (the destination of the first request of tpw issuance on the day), the flow for tpw issuance at Embodiment 1 is performed. Then, the U_{M} (APP) receives tpw from the C⁽¹⁾.

The U_{M} (APP) receiving the tpw, performs the following process between the U_{M} (APP) and each of other C^{(J)} in which the U is registered (Here, J is an integer greater than or equal to 2). U_{M} (APP) sends a request of tpw issuance associated with the tpw received from the C⁽¹⁾, to the C^{(J)}. The C^{(J)} receives the request of tpw issuance associated with the tpw. The C^{(J)}, without newly issuing tpw, sends the tpw related to the received request of tpw issuance to each Sᵢ^{(J)} registered in the C^{(J)}. The C^{(J)} receives the response including eMesᵢ^{(J)} from each Sᵢ^{(J)}. And, the C^{(J)} sends the response including {eMesᵢ^{(J)}}_{M} (M=sysIDᵢ^{(J)}εSYSIDPart) to the U_{M} (APP), and the U_{M} (APP) receives the response.

Thus, the U_{M} (APP) notifies the tpw to each of all C^{(J)} except for the C⁽¹⁾ (sends a request of tpw issuance associated with the tpw), and receives, from each of all the C^{(J)} except for the C⁽¹⁾, the response including {eMesᵢ^{(J)}}_{M}. In the case where this series of processes is finished, the U, during the day, using an identical tpw, can log in to (receive service from) any Sᵢ^{(j)} registered to any C^{(j)} (here, j is an integer greater than or equal to 1). Here, in the case where an error occurs in the communication to any C^{(j)} in which the U is registered except for the C⁽¹⁾, the process may be re-started from the flow for tpw issuance between the U_{M} (APP) and the C⁽¹⁾.

### Embodiment 3

In the following, we describe Embodiment 3. Then, we mainly describe the difference from Embodiment 1 or 2, and omit or simplify the description for similarities with Embodiment 1 or 2.

In Embodiment 2, since the U_{M} (APP) needs to send a request of tpw issuance to each C^{(j)}, the number of communication that the U_{M} (APP) performs gets increased.

Then, in Embodiment 3, the number of communication that the U_{M} (APP) performs can be decreased according as C^{(j)} exchanges data (For example, the U_{M} (APP) has only to communicate only to the C⁽¹⁾ among two or more C^{(j)}).

In the following, we describe Embodiment 3 in detail. Then, for simplicity of description, we adopt the following notation rules.
SIDGroup^{(j)}_{SYSIDPart,aID}: The set consisting of all sysIDₓ^{(j)} (εSYSIDPart) for which AID is aID (x means that the value of i may be any);
AID_{SYSIDPart}: The set consisting of AID for each sysIDₓ^{(x)} εSYSIDPart⊂SYSIDGroup in pList;
Pass_{SYSIDPart,aID}: The set consisting of PASS for all account for which SYSID is an element in SYSIDPart, for which AID is aID.

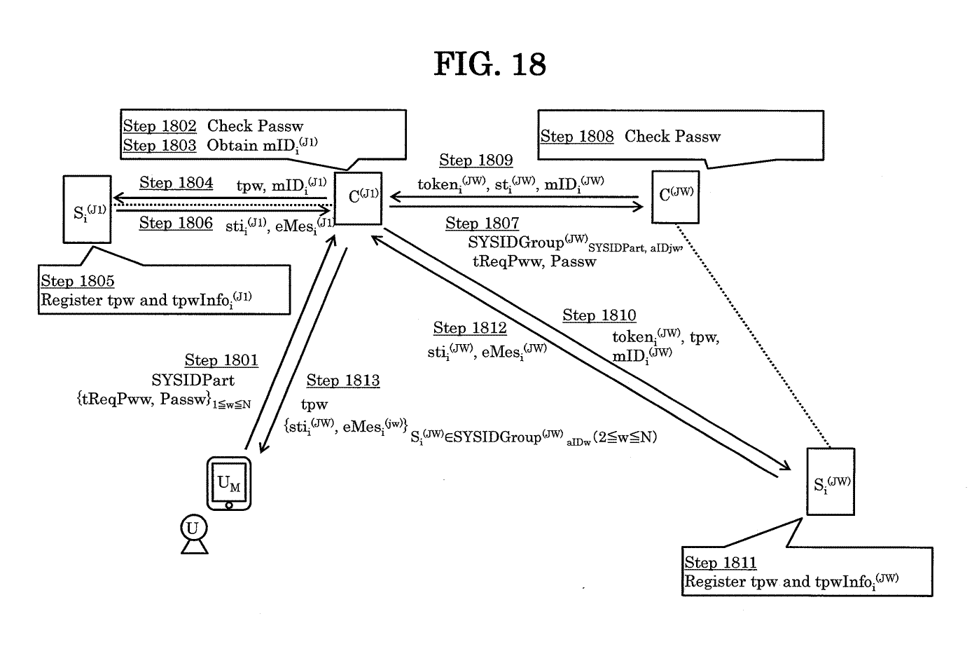

FIG. 18 shows an example of the flow for tpw issuance at Embodiment 3.

(Step 1801) the U chooses SYSIDPart (C SYSIDGroup), and inputs reqPw and SYSIDPart to U_{M} (APP). Then, we suppose that AID_{SYSIDPart} is {aID1, . . . , aIDN}. In the following, one aIDW is taken as an example (1≦W≦N). Let “JW” be the j corresponding to aIDW. The U_{M} (APP) chooses one account having aIDW, computes tReqPwW (=h_{JW}(RAND, SYSID)) (where we suppose SYSID=sysID_{IW}^{(JW)} and RAND=RandW for the account), and obtains PASS (PASS_{IW}^{(JW)} εPass_{SYSIDPart,aIDW}). Let PassW be the obtained PASS. After that, the U_{M} (APP) sends SYSIDPart and {tReqPwW, PassW}_{1≦W≦N} to some C^{(JW)} (here, let it be C^{(J1)}).

(Step 1802) C^{(J1)} judges whether PassW is valid or not.

(Step 1803) In the case where the judgements at Step 1802 is positive, C^{(J1)} refers to aList^{(J1)}, and obtains MID (mIDᵢ^{(J1)}) for each account which has the same AID with aIDJ1 included in Pass1, and for which SYSID (sysIDᵢ^{(J1)}) is an element in SYSIDPart. In the case where the judgements at Step 1802 is negative, the C^{(J1)} sets the value stᵢ^{(J1)} of the state to be “false” for each of all sysIDᵢ^{(J1)} εSYSIDGroup^{(J1)}_{SYSIDPart,aIDJ1}. C^{(J1)} manages stᵢ^{(J1)} for every Sᵢ^{(J1)}. stᵢ^{(J1)} means whether the registration of tpw is successful (true) or not (false).

(Step 1804) The C^{(J1)} issues tpw, and, sends the tpw and the mIDᵢ^{(J1)} to each Sᵢ^{(J1)} identified in the case where the judgement at Step 1802 is positive.

(Step 1805) The Sᵢ^{(J1)} that receives the tpw and the mIDᵢ^{(J1)}, identifies the account to which mIDᵢ^{(J1)} is registered from uListᵢ^{(J1)}, determines tpwInfoᵢ^{(J1)}, and generates mesᵢ^{(J1)} including the tpwInfoᵢ^{(J1)}. The Sᵢ^{(J1)} registers, to the identified account, the received the tpw as TPW, and registers the determined tpwInfoᵢ^{(J1)} as TPWINFO. Also, the Sᵢ^{(J1)} sets the value of stᵢ^{(J1)} to be “true”. Here, in case, for example, that there does not exist any concerned the U in Sᵢ^{(J1)}, the value of stᵢ^{(J1)} is set to be “false”.

(Step 1806) Each Sᵢ^{(J1)} (εSYSIDPart) obtains SUKEY (suKeyᵢ^{(J1)}) registered for the concerned account, and sends the value stᵢ^{(J1)} of the state and eMesᵢ^{(J1)}=Enc_{SUKEY} (mesᵢ^{(J1)}), to the C^{(J1)} (SUKEY=suKeyᵢ^{(J1)}). At this stage, the C^{(J1)} turns out to have received the values of stₓ^{(x)} and eMesₓ^{(x)} from all Sᵢ^{(J1)} (εSYSIDPart) registered in C^{(J1)}. After that, the C^{(J1)} executes the following for 2≦W≦N. Here, we suppose that JW≠J1 for each W (≠1). In the cast where there exists a W with JW=J1, C^{(J1)} itself has only to do the process from Step 1802 to Step 1806 using the identical tpw without newly issuing a tpw.

(Step 1807) The C^{(J1)} sends SYSIDGroup^{(JW)}_{SYSIDPart,aIDJW}, tReqPwW and PassW, to C^{(JW)}.

(Step 1808) C^{(JW)} judges whether PassW is valid or not. In the case where this judgement is positive, the C^{(JW)} identifies the account in aList^{(JW)} using aIDW included in PassW, obtains MID ({mIDᵢ^{(JW)}}_{B}) (B=SYSIDεSYSIDGroup^{(JW)}_{SYSIDPart,aIDJW}), and temporarily sets the value of stᵢ^{(JW)} to be “true”. In the case where PassW is invalid, for all service systems (in the case where MID cannot be obtained with some reason, for service systems for which MID cannot be obtained), the C^{(JW)} sets the value of stᵢ^{(JW)} to be “false”.

(Step 1809) The C^{(JW)} generates an access token (tokenᵢ^{(JW)}) for each Sᵢ^{(JW)} εSYSIDGroup^{(JW)}_{aIDW} such that stᵢ^{(JW)}=true. C^{(JW)} sends tokenᵢ^{(JW)}, stᵢ^{(JW)} and mIDᵢ^{(JW)} to the C^{(J1)} (tokenᵢ^{(JW)} may include stᵢ^{(JW)} and mIDᵢ^{(JW)}). At this stage, C^{(J1)} has received {stᵢ^{(JW)}, mIDᵢ^{(JW)}, tokenᵢ^{(JW)}}_{B} from each of C^{(J2)}, . . . , C^{(JN)} (B=SYSIDεSYSIDGroup^{(JW)}_{SYSIDPart,aIDJW}).

(Step 1810) The C^{(J1)} sends mIDᵢ^{(JW)}, tpw and tokenᵢ^{(JW)} only to Sᵢ^{(JW)} such that stᵢ^{(JW)}=true.

(Step 1811) Each Sᵢ^{(JW)} receiving mIDᵢ^{(JW)}, tpw and tokenᵢ^{(JW)}, judges whether tokenᵢ^{(JW)} is valid or not. In the case where this judgement is positive, Sᵢ^{(JW)} identifies the account for which mIDᵢ^{(JW)} is registered, determines tpwInfoᵢ^{(JW)} and generates mesᵢ^{(JW)} including the tpwInfoᵢ^{(JW)}. Sᵢ^{(JW)} registers, to the identified account, the received tpw as TPW, and registers the determined twpInfoᵢ^{(JW)} as TPWINFO. Sᵢ^{(JW)} generates eMesᵢ^{(JW)}=Enc_{SUKEY}(mesᵢ^{(JW)}) (SUKEY=suKeyᵢ^{(JW)}). Sᵢ^{(JW)} sets the value of stᵢ^{(JW)} to be “true”. Sᵢ^{(JW)} returns stᵢ^{(JW)} and eMesᵢ^{(JW)} to C^{(J1)}. Here, in case, for example, that tokenᵢ^{(JW)} is invalid, Sᵢ^{(JW)} may set the value of stᵢ^{(JW)} to be “false”, and may return the stᵢ^{(JW)} to the C^{(J1)}.

(Step 1812) The C^{(J1)} receives, from Sᵢ^{(JW)}, the response including stᵢ^{(JW)} and eMesᵢ^{(JW)}.

(Step 1813) The C^{(J1)}, in case of receiving the response including stᵢ^{(JW)} and eMesᵢ^{(JW)} from each Sᵢ^{(JW)} εSYSIDGroup^{(JW)}_{aIDw} (2≦w≦N), returns the tpw issued at Step 1804 and all (stᵢ^{(JW)}, eMesᵢ^{(JW)}) to the U_{M} (APP).

According as the U_{M} (APP) decrypts each eMesᵢ^{(JW)}, the U can obtain tpw which is available for all Sᵢ^{(JW)} ⊂SYSIDPart and tpwInfoᵢ^{(JW)} sent by each Sᵢ^{(JW)} ⊂SYSIDPart (information including the expiration date etc.).

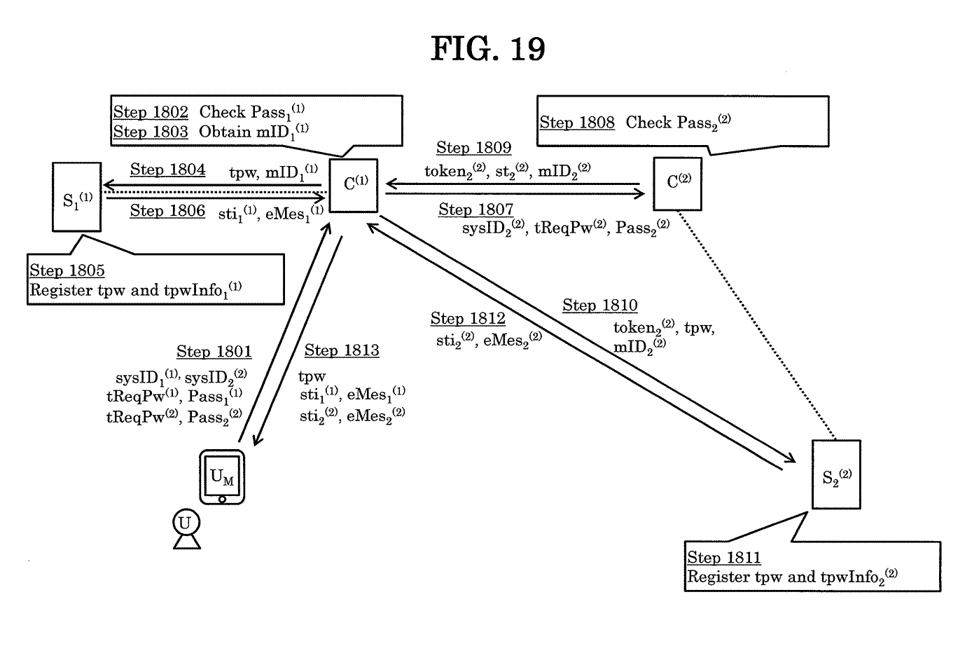

We show, in FIG. 19, a concrete example of the flow for tpw issuance shown in FIG. 18. That is, in the case where the U is registered to C⁽¹⁾, C⁽²⁾, S₁⁽¹⁾ and S₂⁽²⁾, and that the U sends a request of issuance for tpw (a common 1-day password) for S₁⁽¹⁾ and the S₂⁽²⁾ (SYSIDPart={S₁⁽¹⁾, S₂⁽²⁾}), the exchange among the U_{M} (APP), the C⁽¹⁾, the C⁽²⁾, the S₁⁽¹⁾ and the S₂⁽²⁾ follows as FIG. 19 (The same step numbers with the step numbers mentioned in FIG. 18 are used). In FIG. 19, the C^{(J1)} is supposed to be the C⁽¹⁾, and C^{(JW)} is supposed to be the C⁽²⁾.

### Embodiment 4

In the following, we describe Embodiment 4. Then, we mainly describe the difference from Embodiments 1 to 3, and omit or simplify the description for similarities with Embodiments 1 to 3.

In Embodiment 4, concerned with an issuance of a common password (tpw) for plural Sᵢ^{(JW)} registered in plural C^{(JW)}, the C^{(J1)} entrusts other C^{(JW)} with the registration process for Sᵢ^{(JW)} registered in the C^{(JW)}.

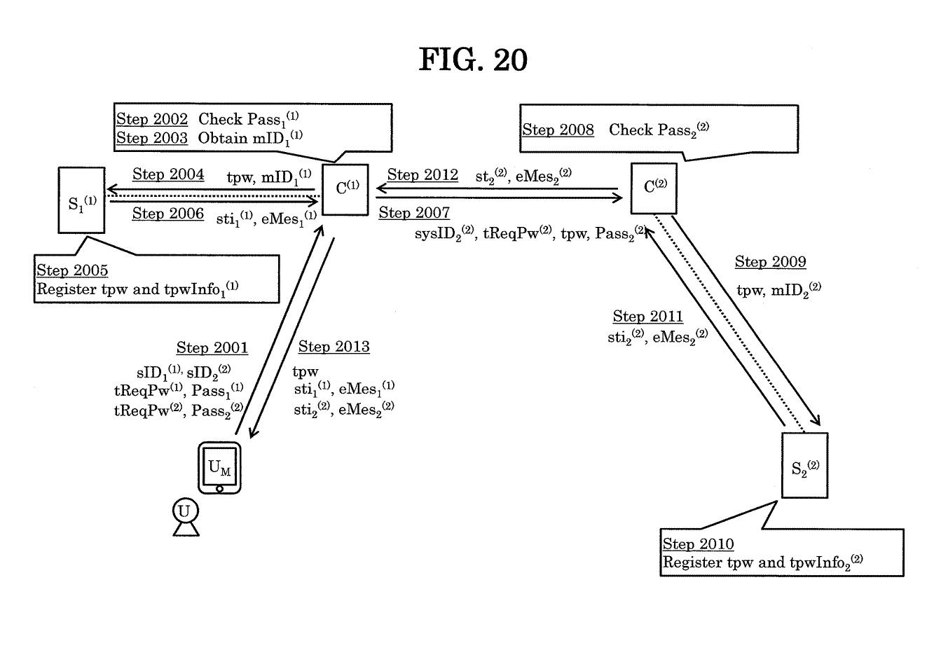

FIG. 20 shows an example of the flow for tpw issuance at Embodiment 4. We describe mainly the difference from FIG. 19. Then, C^{(J1)} is set to be C⁽¹⁾, and C^{(JW)} is set to be C⁽²⁾.

The same process with Steps 1801 to 1806 (Steps 2001 to 2006). The C⁽¹⁾ sends tpw besides sysID₂⁽²⁾, tReqPw⁽²⁾ and Pass₂⁽²⁾, to the C⁽²⁾ (Step 2007), and the C⁽²⁾ receives tpw, sysID₂⁽²⁾, tReqPw⁽²⁾ and Pass₂⁽²⁾ from the C⁽¹⁾, and judges whether Pass₂⁽²⁾ is valid or not (Step 2008). In the case where the judgement is positive, the C⁽²⁾ sends tpw and mID₂⁽²⁾ to the S₂⁽²⁾ (Step 2009). The S₂⁽²⁾ registers the tpw and the tpwInfo₂⁽²⁾ to uList₂⁽²⁾ (Step 2010), and returns st₂⁽²⁾ and eMes₂⁽²⁾ to C⁽²⁾ (Step 2011). The C⁽²⁾ sends the st₂⁽²⁾ and the eMes₂⁽²⁾ to C⁽¹⁾ (Step 2012). Namely, st₂⁽²⁾ and eMes₂⁽²⁾ are sent from S₂⁽²⁾ to C⁽¹⁾ via C⁽²⁾. After that, the C⁽¹⁾ returns tpw, (st₁⁽¹⁾, eMes₁⁽¹⁾) and (st₂⁽²⁾, eMes₂⁽²⁾) respectively received from S₁⁽¹⁾ and S₂⁽²⁾, to the U_{M} (APP) (Step 2013).

Since Sᵢ^{(JW)} (JW≠J1) is not service systems registered to C^{(J1)}, the C^{(J1)} cannot primarily register tpw to Sᵢ^{(JW)}. Then, in Embodiment 3 described above, C^{(JW)} issues an access token (tokenᵢ^{(JW)}) for enabling tpw registration to Sᵢ^{(JW)} registered in its own sList^{(JW)}, and sends it together with mIDᵢ^{(JW)} to C^{(J1)}. According as a secret key cKeyᵢ^{(JW)} is shared by C^{(JW)} and each Sᵢ^{(JW)}, mIDᵢ^{(JW)} can be, in encrypted style, sent to C^{(J1)}. The tokenᵢ^{(JW)} may be a one-time signature, but its expiration date for tokenᵢ^{(JW)}, restriction on authority etc. may be related to tokenᵢ^{(JW)}, in which case C^{(J1)} can use, even after the next time, the sysIDᵢ^{(JW)}, mIDᵢ^{(JW)} and tokenᵢ^{(JW)} received first. Therefore, the communication between C^{(J1)} and C^{(JW)}, and, the communication between C^{(JW)} and Sₓ^{(JW)}, can be abbreviated.

### Embodiment 5

In the following, we describe Embodiment 5. Then, we describe mainly the difference from Embodiments 1 to 4, and omit or simplify the description for similarities with Embodiments 1 to 4.

Whereas in Embodiments 3 and 4, a method based on so-called ID cooperation is adopted (mID shall be cooperated among control center machines), in Embodiment 5, a method base on single sign-on such as SAML (Security Assertion Markup Language) is adopted. S₂⁽²⁾ (Sᵢ^{(JW)}) has the function as Policy enforcement point 2100.

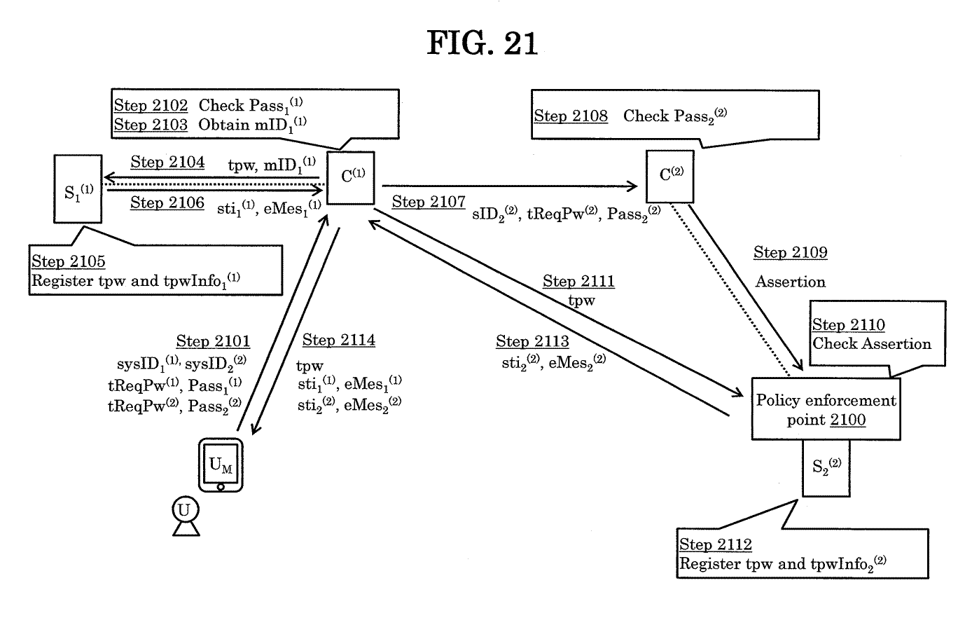

FIG. 21 shows an example of the flow for tpw issuance at Embodiment 5. We mainly describe the difference from FIG. 19.

The same processes with Steps 1801 up to 1806 are performed (Step 2101 up to Step 2106). C⁽¹⁾ sends sysID₂⁽²⁾, tReqPw⁽²⁾ and Pass₂⁽²⁾ to C⁽²⁾ (Step 2107). The C⁽²⁾ receives sysID₂⁽²⁾, tReqPw⁽²⁾ and Pass₂⁽²⁾ from C⁽¹⁾, and judges whether Pass₂⁽²⁾ is valid or not (Step 2108).

In the case where the judgement at Step 2108 is positive, the C⁽²⁾ sends an assertion (data including mID₂⁽²⁾) such as authentication state, attributes (mID₂⁽²⁾ etc.) and authority (for such as password registration) to S₂⁽²⁾ (Step 2109). In other words, the C⁽²⁾ (C^{(JW)}) does not have to notify mID₂⁽²⁾ (mIDᵢ^{(JW)}) registered in uList₂⁽²⁾ (uListᵢ^{(JW)}), to C⁽¹⁾ (C^{(J1)}).

The S₂⁽²⁾ judges whether the assertion is valid with Policy enforcement point 2100 (Step 2110). The S₂⁽²⁾, in the case where the judgement is positive, may notify the judgement (OK) to the C⁽¹⁾, and may keep the judgement without notifying to the C⁽¹⁾.

The C⁽¹⁾ notifies tpw to the S₂⁽²⁾ (Step 2111). For example, the C⁽¹⁾, knowing the information necessary for communication with the S₂⁽²⁾ corresponding to sysID₂⁽²⁾, may send the notification to the S₂⁽²⁾ using that information, and the C⁽²⁾, at the timing such as when it sends the assertion to the S₂⁽²⁾, may notify the information necessary for communication with the S₂⁽²⁾ to the C⁽¹⁾. Also, the tpw notification from the C⁽¹⁾ to the S₂⁽²⁾ may be performed responding the judgement above from the S₂⁽²⁾, and may be performed, for example, periodically, without the judgement above from the S₂⁽²⁾. The S₂⁽²⁾, in case of receiving tpw from the C⁽¹⁾, determines tpwInfo₂⁽²⁾, and registers tpw and tpwInfo₂⁽²⁾ to uList₂⁽²⁾ (step 2112). This registration is performed in the case where that the judgement at Step 2110 is positive.

After that, the S₂⁽²⁾ returns st₂⁽²⁾ and eMes₂⁽²⁾ to the C⁽¹⁾ (Step 2113) The C⁽¹⁾ returns tpw, (st₁⁽¹⁾, eMes₁⁽¹⁾) and (st₂⁽²⁾, eMes₂⁽²⁾) received from the S₁⁽¹⁾ and the S₂⁽²⁾ respectively, to the U_{M} (APP) (Step 2113).

### Embodiment 6

In the following, we describe Embodiment 6. Then, we mainly describe the difference from Embodiments 1 to 5, and omit or simplify the description for similarities with Embodiments 1 to 5.

In Embodiments 1 to 5, tpw issuance is performed. In Embodiment 6, instead of or besides tpw issuance, another controls for tpw such as tpw alternation and tpw deletion, is performed. Specifically, for example, a request of tpw issuance is an example of requests of tpw control. An example of tpw control is tpw issuance, and an example of control center machine (identification code control apparatus or identification code control system) is a control center machine. The information elements that are related to the request of tpw control, may be the same with the information elements that are related to the request of tpw issuance. APP is used also for tpw control other than tpw issuance besides tpw issuance. In the following, as another example of requests of tpw control, taking tpw deletion as an example, we describe tpw control. Here, “tpw deletion” means “to nullify tpw so that anyone including U disable to log in until the next request of tpw issuance is performed”.

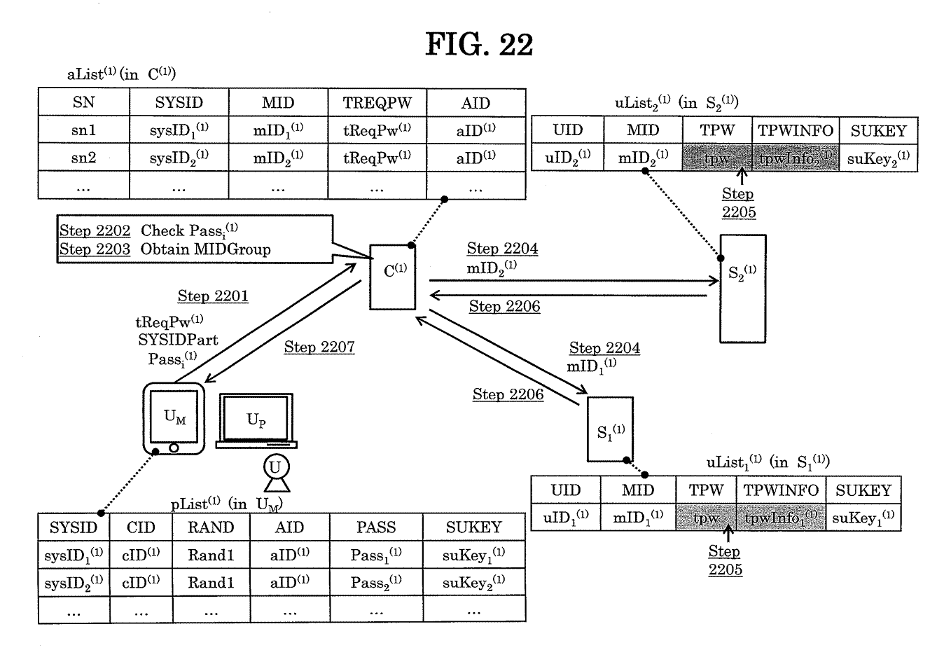

FIG. 22 shows an example of the flow for tpw deletion at Embodiment 6.

(Step 2201) The U_{M} (APP) performs a similar process with Step 1401 in FIG. 14. However, in this embodiment, a request of tpw deletion instead of a request of tpw issuance is sent.

(Step 2202) The C⁽¹⁾ receives a request of tpw deletion from the U_{M} (APP), responds the request, and judges whether Passᵢ⁽¹⁾ related to the request is valid or not.

(Step 2203) The C⁽¹⁾, in the case where the judgement at Step 2202 is positive, refers to the aList⁽¹⁾, and identifies all the account that has AID coinciding with the aID⁽¹⁾ in the Passᵢ⁽¹⁾ judged to be valid and that has SYSID coinciding with some sysIDᵢ⁽¹⁾ in SYSIDPart related to the request of tpw deletion. The C⁽¹⁾ obtains the respective MID (mIDᵢ⁽¹⁾) for all the identified accounts.

(Step 2204) C⁽¹⁾ performs the following for each sysIDᵢ⁽¹⁾ (εSYSIDPart). In the description for Steps 2204 to 2207, one sysIDᵢ⁽¹⁾ is taken as an example. The C⁽¹⁾ sends a request of tpw deletion associated with mIDᵢ⁽¹⁾ corresponding to the Sᵢ⁽¹⁾, to Sᵢ⁽¹⁾ corresponding to Sᵢ⁽¹⁾.

(Step 2205) The Sᵢ⁽¹⁾ receives the request of tpw deletion associated with the mIDᵢ⁽¹⁾ from the C⁽¹⁾. The Sᵢ⁽¹⁾ identifies the account for which MID coinciding with the mIDᵢ⁽¹⁾ related to the received request is registered. The Sᵢ⁽¹⁾ deletes the information elements of tpw and tpwInfo for the identified account.

(Step 2206) The Sᵢ⁽¹⁾ sends the response for the completion of deletion.

(Step 2207) The C⁽¹⁾, in the case where it receives the responses from all the Sᵢ⁽¹⁾ corresponding to sysIDᵢ⁽¹⁾ (εSYSIDPart), sends the response for the request of tpw deletion, to the U_{M} (APP). The U_{M} (APP) receives the response from the C⁽¹⁾.

According to Embodiment 6, it is possible to control on tpw for all the Sᵢ⁽¹⁾ corresponding to all the accounts with the same aID⁽¹⁾ with the aID⁽¹⁾ corresponding to the chosen Passᵢ⁽¹⁾. For example, tpw deletion seems to be effective in the case where, instead of tpw, a password with no restriction for the expiration date or the frequency of possible use is registered as the common password (Namely, whereas in the embodiment, the adopted password is a common 1-day password, not only such a password but also a password with no restriction for the expiration date or the frequency of possible use may be adopted).

### Embodiment 7

In the following, we describe Embodiment 7. Then, we describe mainly the difference from Embodiments 1 to 6, and omit or simplify the description for similarities with Embodiments 1 to 6.

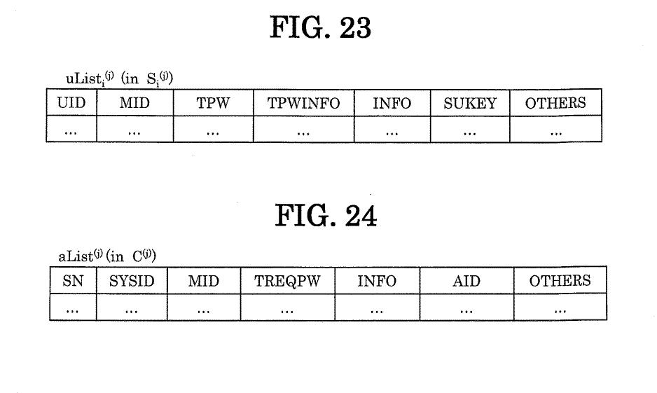

In Embodiment 7, at least one Sᵢ^{(j)} sends Infoᵢ^{(j)} to a certain control center machine. The “certain control center machine” is, for example, the control center machine that the Sᵢ^{(j)} is registered to, the control center machine that is the sender of the prescribed information elements (such as tpw or mIDᵢ^{(j)}), or that control center machine the receives the request of tpw control from U_{M} (APP). “Infoᵢ^{(j)}” is the data output from the issuer Sᵢ^{(j)} of Infoᵢ^{(j)}, and is data including data which may be published to service systems except for Sᵢ^{(j)} (The data include in Infoi(j) has only to be data that is permitted to be so public by U). Infoᵢ^{(j)} may be include, for example, in the response from Sᵢ^{(j)} (the response at Step 1203 in FIG. 12, the response at Step 1303 in FIG. 13, etc.) at Pre-registration, and in the response from Sᵢ^{(j)} in a control such as tpw issuance (the response at Step 1406 in FIG. 14, the response at Step 1812 in FIG. 18, the response at at least one of Step 2011 and Step 2012 in FIG. 20, Step 2113 in FIG. 21, etc.). Then, as shown in FIG. 23, The issued Infoᵢ^{(j)} is registered to uListᵢ^{(j)} in Sᵢ^{(j)} that has issued Infoᵢ^{(j)} (INFO). Also, Infoᵢ^{(j)} assemble to a certain control center machine, and Infoᵢ^{(j)} shall be registered in aList^{(j)} in the control center machine. Infoᵢ^{(j)} may include data on the permitted publishing destination service system (such as sysIDᵢ^{(j)} and the name of the company offering the service system) and the publishing period, etc.

Sᵢ^{(j)}, receiving an application from the U, in the case where a certain type of information is necessary for the process for the application, may send a query on the certain type of information (for example, a query associated with mIDᵢ^{(j)} corresponding to the applicant U), to the certain control center machine (or, C^{(j)} that Sᵢ^{(j)} receiving the application is registered in) (The query may be transfer from C^{(j)} receiving the query from Sᵢ^{(j)} to the certain control center machine above). The control center machine receiving the query, as the response for the application, may send the information that is data in Infoᵢ^{(j)} corresponding to mIDᵢ^{(j)}, and is permitted to be so published (for example, a resume, a resident card, etc.), to the query origin Sᵢ^{(j)}.

### Embodiment 8

In the following, we describe Embodiment 8. Then, we describe mainly the difference from Embodiments 1 to 7, and omit or simplify the description for similarities with Embodiments 1 to 7. Here, Embodiment 8 may be an example of variants or a specific example for Embodiment 7.

Each service system to which the U is registered manages U's personal information (for example, a certificates of graduation, a certificates of qualification, a resume, a medical record, the personal identity number (and its accompanying data), etc.). The progress for convenience can be expected as the U's personal information comes to be cooperated among service systems at least while the U permits. Also, whereas the cooperated information may be other types of information on the U instead of or besides the U's personal information, at least according to the types of information being the target of cooperation, at least a part of the information being the cooperation target must not be shown to the unidentified (for example, anyone except for the U and entities permitted to which the U permits (such as the cooperation origin and the cooperation destinations)).

In Embodiment 8, information can be cooperated among service systems without being shown to the unidentified.

Also, in Embodiment 8, in the registration flow, the U can know the information being registered to Sᵢ^{(j)}.

Also, Embodiment 8, existing specification on transfer of authorization data such as OAuth can be applied.

In the following, we describe an example of each of the flow for registration and the flow for information cooperation (Information Sharing) at Embodiment 8.

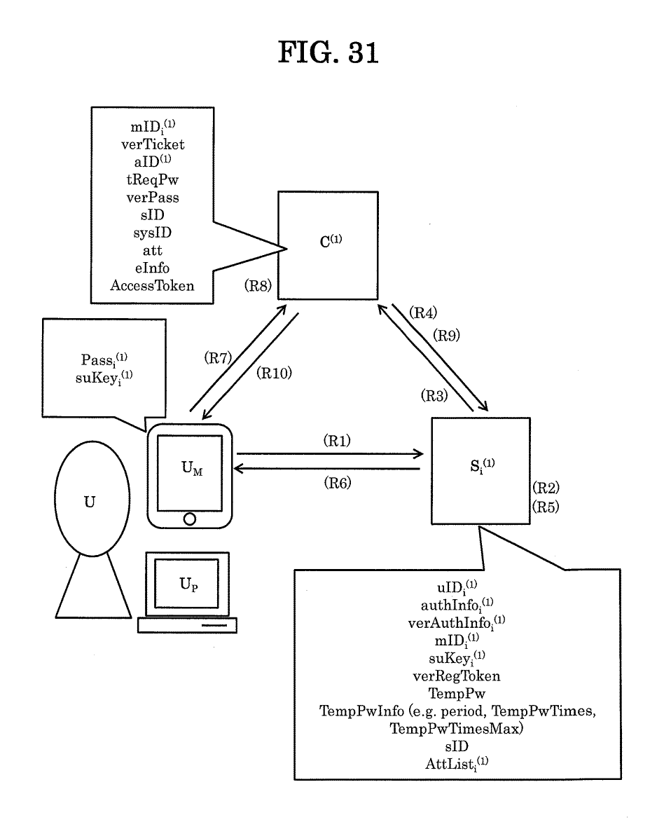

FIG. 31 shows an example of the flow for registration at Embodiment 8. Here, for simplicity of description, we suppose that only the C⁽¹⁾ exists as C^{(j)} (FIG. 31 shows only S₁⁽¹⁾ among plural Sᵢ⁽¹⁾).

At the time of finishing the registration flow, the information elements below are stored in the U_{M}. The information elements below are registered in pList. Also, at least one of the information elements below may be stored after being encrypted using data including the U_{M} specific data as the key.
Passᵢ⁽¹⁾: request data for the approval for request to send to C⁽¹⁾ (a request pass);
suKeyᵢ⁽¹⁾: shared key necessary for communication with Sᵢ⁽¹⁾.

At the time of finishing the registration flow, the information elements below are stored in Sᵢ⁽¹⁾. The information elements below are registered in uListᵢ⁽¹⁾. At least one of the information elements below may be stored after being encrypted.
uIDᵢ⁽¹⁾: user ID for use of Sᵢ⁽¹⁾ and data shared by U and Sᵢ⁽¹⁾;
authInfoᵢ⁽¹⁾: authentication data for U (for example, a password except for TempPw (such as a fixed password));
verAuthInfoᵢ⁽¹⁾: data to verify authInfoᵢ⁽¹⁾;
mIDᵢ⁽¹⁾: ID for management in Sᵢ⁽¹⁾ and data shared by C⁽¹⁾ and Sᵢ⁽¹⁾ (distinct for each U). Here, at information sharing, mIDᵢ⁽¹⁾ for the sharing origin or the sharing destination is stored;
suKeyᵢ⁽¹⁾: shared key necessary for communication with U_{M};
verRegToken: data to verify a checking token for registration completed (regToken);
TempPw: temporary password (such as tpw);
TempPwInfo: information on restriction for TempPw, including at least one of the expiration date (period), the frequency of use (TempPwTimes) and the frequency of possible use (TempPwTimesMax);
sID: sharing ID. It is an ID used at information sharing, and is an ID for uniquely identifying the sharing;
AttListᵢ⁽¹⁾: list of attribution data (att) (the details are described later).

At the time of finishing the registration flow, the information elements below are registered in the C⁽¹⁾. The information elements below are registered in at least aList⁽¹⁾ among aList⁽¹⁾, sList⁽¹⁾ and cList⁽¹⁾. At least one of the information elements below may be stored after being encrypted.
mIDᵢ⁽¹⁾: ID for management in Sᵢ⁽¹⁾ and data shared by C⁽¹⁾ and Sᵢ⁽¹⁾ (distinct for each U). Here, at information sharing, mIDᵢ⁽¹⁾ for the sharing origin and mIDᵢ⁽¹⁾ for the sharing destination are stored;
verTicket: data necessary to verify a registration ticket (ticket) for an account in aList⁽¹⁾;
aID⁽¹⁾: ID for APP. As described above, plural distinct aID⁽¹⁾ may exist for one C^{(j)} and one APP;
tReqPw: password for requests;
verPassᵢ⁽¹⁾: data necessary to verify Passᵢ⁽¹⁾ (device authentication for U_{M});
sID: sharing ID;
sysIDᵢ⁽¹⁾: ID for the service system Sᵢ⁽¹⁾;
att: attribution data (such as the name, the mail address, etc.) Offerable att and acceptable att are stored as att. Data including one or more values of att (the values following att) is a sharing target data (Info);
eInfo: sharing target data (Info) after being encrypted;
AccessToken: access token at OAuth, that is, a token used for communication between C⁽¹⁾ and Sᵢ⁽¹⁾.

The registration flow, as shown in FIG. 31, is following.

The registration flow consists of First registration procedure that is a procedure between the U and the Sᵢ⁽¹⁾ and the Second registration procedure that is a procedure between the U and the C⁽¹⁾. The First registration procedure is constructed with the following (R1) up to (R6), and Second registration procedure is constructed with the following (R7) to (R10).

(R1) The U_{M} (such as APP) sends user data along the policy of the Sᵢ⁽¹⁾, and determines uIDᵢ⁽¹⁾ and authInfoᵢ⁽¹⁾ for logging in to the Sᵢ⁽¹⁾.

(R2) The Sᵢ⁽¹⁾ converts the user data received at (R1), and stores it.

(R3) The Sᵢ⁽¹⁾ sends a request of account addition associated with sysIDᵢ⁽¹⁾ and a registration password (rpw), to the C⁽¹⁾. Here, the rpw may be a data that the U itself determines and that is notified to the Sᵢ⁽¹⁾ by the U_{M} (or the U_{P}), and may be a data that determined by the Sᵢ⁽¹⁾. The C⁽¹⁾ receives the request of account addition associated with sysIDᵢ⁽¹⁾ and rpw.

(R4) The C⁽¹⁾, responding to the request of account addition, performs the following process. Namely, the C⁽¹⁾ makes one account (for example, adds an account in the aList⁽¹⁾), and assigns (registers) the mIDᵢ⁽¹⁾ to the account. Furthermore, the C⁽¹⁾ generates a registration ticket (ticket) for the account. After that, the C⁽¹⁾ registers the assigned mIDᵢ⁽¹⁾, the received sysIDᵢ⁽¹⁾ and verTicket (data necessary for verifying the validity of the registration ticket) to its own database (such as the aList⁽¹⁾). In the ticket, data for identifying the corresponding account is included. C⁽¹⁾ sends the assigned mIDᵢ⁽¹⁾ and the generated ticket, to the Sᵢ⁽¹⁾. The Sᵢ⁽¹⁾ receives the mIDᵢ⁽¹⁾ and the ticket.

(R5) The Sᵢ⁽¹⁾ adds one account (adds one account in the uListᵢ⁽¹⁾), determines a key suKeyᵢ⁽¹⁾ necessary for communication with U_{M}, and registers uIDᵢ⁽¹⁾, mIDᵢ⁽¹⁾ and suKeyᵢ⁽¹⁾ to the account. Furthermore, the Sᵢ⁽¹⁾ generates a checking token for registration completed (regToken), and registers the data necessary to verify it (verRegToken) to the concerned account.

(R6) The Sᵢ⁽¹⁾ sends the ticket, the suKeyᵢ⁽¹⁾ and the regToken to the U_{M}. The U_{M} receives the ticket, the suKeyᵢ⁽¹⁾ and the regToken. Here, in the case where the U itself determines rpw, the Sᵢ⁽¹⁾ sends also the rpw to the U_{M}. Also, it is not compulsory to determine and send regToken.

(R7) The U_{M} sends a registration request associated with the ticket, the suKeyᵢ⁽¹⁾, the rpw, the regToken and the reqPw, to the C⁽¹⁾. The C⁽¹⁾ receives the registration request associated with the ticket, the suKeyᵢ⁽¹⁾, the rpw, the regToken and the reqPw. The ticket, the suKeyᵢ⁽¹⁾, the rpw and the regToken may be data received from the Sᵢ⁽¹⁾, and may be data input by the U. The reqPw may be data determined by the U or the APP.

(R8) The C⁽¹⁾, in response to the registration request, performs the successive process. Namely, the C⁽¹⁾, using verTicket (and rpw), verifies the validity of ticket. In the case where the ticket is valid, the C⁽¹⁾ identifies the account with ticket, generates aID⁽¹⁾ and Passᵢ⁽¹⁾, and registers them. Also, the C⁽¹⁾ registers, to the identified account, the aID⁽¹⁾ and the data necessary for verifying Passᵢ⁽¹⁾ and reqPw related to the registration request (verTReqPw (data necessary for verifying tReqPw) and verPassᵢ⁽¹⁾ (data necessary for verifying Passᵢ⁽¹⁾)). In the Passᵢ⁽¹⁾, data for identifying an account in the C⁽¹⁾ (such as aID⁽¹⁾), and data for U's identifying a registration destination Sᵢ⁽¹⁾ (such as sysIDᵢ⁽¹⁾) are included. Here, at (R8), we may make the U perform OAuth authentication, and may register AccessToken based on the authentication result after being encrypted, to the account.

(R9) The C⁽¹⁾ sends the mIDᵢ⁽¹⁾ and the regToken to the Sᵢ⁽¹⁾. The Sᵢ⁽¹⁾ receives the mIDᵢ⁽¹⁾ and the regToken, and verifies the regToken using verRegToken for the account that the received mIDᵢ⁽¹⁾ is registered to. In the case where the regToken is valid, the Sᵢ⁽¹⁾ recognizes that the account gets enable to use authentication among three entities.

(R10) The C⁽¹⁾ sends the Passᵢ⁽¹⁾ to the U_{M}. The U_{M} receives the Passᵢ⁽¹⁾ and stores the Passᵢ⁽¹⁾ and the suKeyᵢ⁽¹⁾.

The aforementioned is the description for the registration flow at Embodiment 8. Here, in Embodiment 8, for the registration flow, any registration flow at other embodiments may be adopted instead of the registration flow described referring to FIG. 31. Or, the registration flow at Embodiment 8 may be adopted at any other embodiments. Also, whereas OAuth may be adopted at any other embodiments instead of or besides Embodiment 8, at least, OAuth is not mandatory for the present invention.

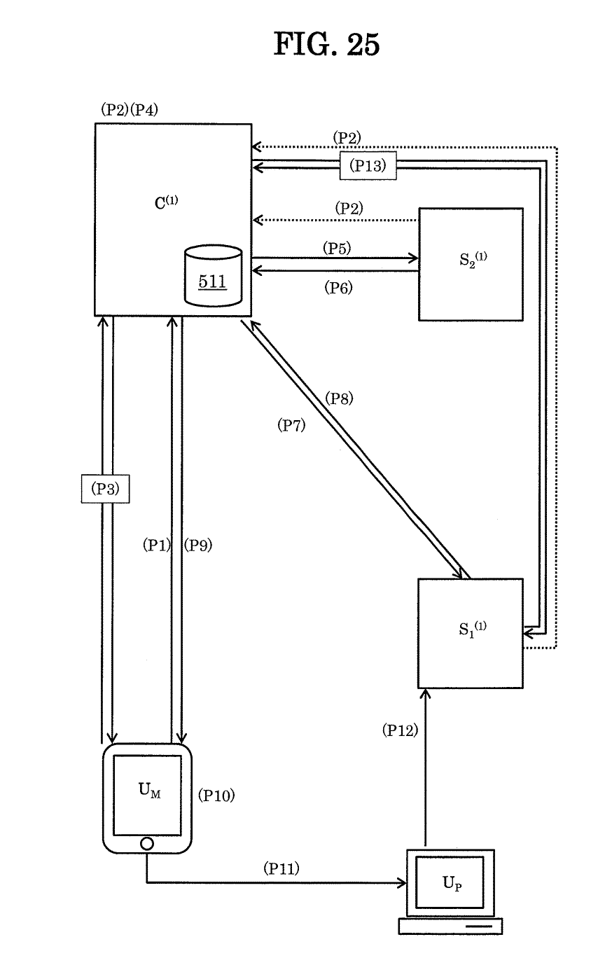

FIG. 25 shows an example of the flow for authentication and sharing at Embodiment 8. Here, in the following description, we suppose that, as Sᵢ^{(j)}, there are plural Sᵢ⁽¹⁾ including S₁⁽¹⁾ and S₂⁽¹⁾. Also, in the following description, we suppose that in use of Sᵢ⁽¹⁾ (Service A), data which S₁⁽¹⁾ desires is the same with the data kept in S₂⁽¹⁾ (Service B), and hence U wants to offer the data kept in S₂⁽¹⁾ to S₁⁽¹⁾. Thus, S₂⁽¹⁾ is the sharing origin service system, and S₁⁽¹⁾ is the sharing destination service system. Also, in the following description, processes with “(Authentication)” at the beginning are processes executed only in case of issuance of TempPw such as tpw. Processes with “(Sharing)” at the beginning are processes executed only in case of information sharing. Processes with neither “(Authentication)” nor “(Sharing)” are processes executed in any case of TempPw issuance and information sharing.

(P1)

The U_{M} (APP) receives the choice of op from the U. “op” is the type of operation for the target of the request, and specifically, for example, authentication, information sharing, or both of them. In the case where “authentication” is chosen, hereafter, the processes with “(Authentication)” at the beginning is supposed to be performed. In the case where “information sharing” is chosen, hereafter, the processes with “(Sharing)” at the beginning is supposed to be performed. In the case where “both of them” is chosen, hereafter, the processes with “(Authentication)” and the processes with “(Sharing)” at the beginning, is supposed to be performed. Here, for the overlap between the processes with “(Authentication)” at the beginning and the processes with “(Sharing)” at the beginning, once it has been performed at the one process, it may not be performed at the other process. U_{M} (APP) displays the list of sysIDᵢ⁽¹⁾ identified with all Passᵢ⁽¹⁾ stored in U_{M}.

(Authentication): The U_{M} (APP) receives the choice of aID^{(1)A} (or sysID₁⁽¹⁾) from the displayed list. aID^{(1)A} is aID⁽¹⁾ for the account that sysID₁⁽¹⁾ for S₁⁽¹⁾ (Service A) that U makes be the login destination is registered to.

(Sharing): The U_{M} (APP) receives the choices of aID^{(1)A} (or sysID₁⁽¹⁾) and aID^{(1)B} (or sysID₂⁽¹⁾). The aID^{(1)A} is aID⁽¹⁾ for the account that sysID₁⁽¹⁾ of the information sharing destination the S₁⁽¹⁾ is registered in. The aID^{(1)B} is aID⁽¹⁾ for the account that sysID₂⁽¹⁾ of the information sharing origin S₂⁽¹⁾ is registered in.

The U_{M} (APP) sends a request associated with the chosen op, Pass for the chosen accounts (at least Pass₁⁽¹⁾ out of Pass₁⁽¹⁾ and Pass₂⁽¹⁾) and tReqPw, to C⁽¹⁾. The tReqPw is reqPw input by the U at (P1), or is a data based it on. The C⁽¹⁾ receives the request associated with op, Pass and tReqPw.

(P2)

The C⁽¹⁾, in response to the received request, performs the successive process. Namely, the C⁽¹⁾ verifies the validities of tReqPw and Pass using verPass and verTReqPw for the account that the received Pass and tReqPw are registered to (hereafter, the target account). In the case where those are valid, the C⁽¹⁾ finds mID₁⁽¹⁾ (and mID₂⁽¹⁾) corresponding to aID^{(1)A} (and aID^{(1)B}) identified with Pass, in the account(s) (such as aList⁽¹⁾).

(Sharing): The C⁽¹⁾, for the S₁⁽¹⁾ corresponding to aID^{(1)A} (mID₁⁽¹⁾, inquires the list (AttList₁⁽¹⁾) of the acceptable attribution data (att), and for the S₂⁽¹⁾ corresponding to aID^{(1)B} (mID₂⁽¹⁾), inquires the list (AttList₂⁽¹⁾) of the offerable attribution data. “AttListᵢ⁽¹⁾” is a list of attribution data (att), including at least one out of acceptable att and offerable att. The AttListᵢ⁽¹⁾ includes both of acceptable att and offerable att, and may be narrowed down to one of acceptable att and offerable att, in being offered in responding the inquiry from the C⁽¹⁾. The AttListᵢ⁽¹⁾ may be a list pre-registered from the Sᵢ⁽¹⁾, and in that case, the inquiry procedure may be omitted. The Sᵢ⁽¹⁾, as described above, stores offerable att and acceptable att in advance.

(P3)

(Sharing): The C⁽¹⁾ sends the intersection (att) of AttList₁⁽¹⁾ and AttList₂⁽¹⁾ to the U_{M}, and the U_{M} displays the intersection (att). U_{M}, from the U, receives the choice of the attribution data att to be shared, and sends the chosen att to the C⁽¹⁾. The C⁽¹⁾ receives the chosen att.

(P4)

(Authentication): The C⁽¹⁾ generates tpw for the target account. Here, we suppose that the tpw is generated, but TempPw of the type other than tpw may be generated.

(Sharing): The C⁽¹⁾ generates a unique sID for the information sharing executed in the flow for this authentication/sharing.

(P5)

(Sharing): The C⁽¹⁾ sends a request (a data offer request) associated with sID and mID₂⁽¹⁾ generated at (P4), att received at (P3), and sysID₁⁽¹⁾ for the sharing destination S₁⁽¹⁾, to the sharing origin S₂⁽¹⁾. At that time, the C⁽¹⁾ may send also AccessToken for OAuth, to the sharing destination S₂⁽¹⁾. In the AccessToken for OAuth, attribution data (att) that may be sent to the S₁⁽¹⁾ without authInfo₁⁽¹⁾ may be described. The sharing origin S₂⁽¹⁾ receives the request associated with sID, mID₂⁽¹⁾, att and sysID₁⁽¹⁾ (and AccessToken).

(P6)

(Sharing): The sharing origin S₂⁽¹⁾, responding to the request, performs the successive process. Namely, the sharing origin S₂⁽¹⁾ encrypts the sharing target data Info including the value if att corresponding to mID₂⁽¹⁾ (the value following att) with a key with which the sharing destination S₁⁽¹⁾ can decrypt. Here, we denote the Info by “InfoB”, according to the meaning that it is data shared from Service B (the S₂⁽¹⁾), and denote the encrypted InfoB by “eInfoBA” according to the meaning that it is data to be shared to Service A (S₁⁽¹⁾). The sharing origin S₂⁽¹⁾ encrypts InfoB with suKey₂⁽¹⁾. We denote the encrypted InfoB by “eInfoUB” according to the meaning that it is encrypted with the key shared with the U. The S₂⁽¹⁾ sends sID, eInfoBA and eInfoUB to the C⁽¹⁾. The C⁽¹⁾ receives sID, eInfoBA and eInfoUB. The C⁽¹⁾ may store the received sID, eInfoBA and eInfoUB to the storage unit 511.

(P7)

(Authentication): The C⁽¹⁾ sends a request associated with mID₁⁽¹⁾ and tpw, to the S₁⁽¹⁾. The S₁⁽¹⁾ receives the request associated with the mID₁⁽¹⁾ and the tpw.

(Sharing): The C⁽¹⁾ sends a request associated with the mID₁⁽¹⁾ and sID, to the sharing destination S₁⁽¹⁾. At that time, the S₁⁽¹⁾ may send AccessToken for OAuth to the S₁⁽¹⁾, too. The sharing destination S₁⁽¹⁾ receives the request associated with the mID₁⁽¹⁾ and sID (and AccessToken).

(P8)

(Authentication): The S₁⁽¹⁾ registers, to the account corresponding to the mID₁⁽¹⁾, the tpw and the tpwInfo for the tpw (such as period, tpwTimesMax), encrypts data including tpw and tpwInfo with suKey₁⁽¹⁾, and returns the encrypted data eTpwInfo to the C⁽¹⁾.

(Sharing) The S₁⁽¹⁾ registers the sID and the mID₁⁽¹⁾ to the corresponding account in a database (such as the uList₁⁽¹⁾).

(P9)

(Authentication): The C⁽¹⁾ sends eTpwInfo (including the encrypted tpw) to the U_{M}.

(Sharing): The C⁽¹⁾ sends eInfoUB to the U_{M}.

(P10)

The U_{M} encrypts the data received at (P9) (at least one out of eTpwInfo and eInfoUB) with suKey₂⁽¹⁾, and displays the decrypted data.

(Sharing): The displayed data is the sharing target data. The U_{M} (APP) may receive the reply whether the sharing for the sharing target data should be approved (OK) or cancelled (NG), and may notify the received reply to the C⁽¹⁾. The U has only to reply “NG” in the case where there is an error in at least a part of the sharing target data, or that the U gets urged not to share, etc. In the case where the reply means “NG” (cancelled), the C⁽¹⁾ is supposed to cancel the sharing, namely, disable the sharing target data to be obtained by the sharing destination S₁⁽¹⁾. Specifically, for example, the C⁽¹⁾, in case of receiving the reply “NG”, deletes eInfoUB (and eInfoBA, sID) from the storage unit 511. Or, the C⁽¹⁾ excludes the sharing destination S₁⁽¹⁾ from the access permission for the sharing target data.

(P11)

The U_{P} accesses to the S₁⁽¹⁾, for example to login, inputs uID₁⁽¹⁾ and authInfo₁⁽¹⁾ to the S₁⁽¹⁾.

(Authentication): the U_{P}, in addition, inputs tpw to the S₁⁽¹⁾.

(P12)

In the case where the input data (uID₁⁽¹⁾ and authInfo₁⁽¹⁾) is correct, the S₁⁽¹⁾ permits the U_{P} to log in.

(P13)

(Sharing): The S₁⁽¹⁾ sends the sID for the sharing process addressed to the mID₁⁽¹⁾ registered to the S₁⁽¹⁾, to the C⁽¹⁾. The C⁽¹⁾ sends eInfo (such as eInfoBA) associated with the sID, to the S₁⁽¹⁾. The S₁⁽¹⁾ receives and decrypts the eInfo (such as eInfoBA) (thus, InfoB is obtained).

According to the information sharing flow described above, information sharing becomes executable by the request (permit) from the U. Also, any of the sharing target data, the sharing origin and the sharing destination can be designated by the U. Therefore, the sharing target data, the sharing origin and the sharing destination can be restricted in scope the U permits.

Also, according to the information sharing flow described above, the sharing target data is, in encrypted state, stored in the storage unit 511 managed by an entity except for the sharing origin or the sharing destination, and the data is decrypted by the sharing destination S₂⁽¹⁾. Hence, it is possible to prevent the unidentified from inspecting the sharing target data.

Here, in the information sharing flow described above, the C⁽¹⁾ may store, besides eInfoBA, a certificate guaranteeing that the eInfoBA is a data coming from Service B (the S₂⁽¹⁾), in the storage unit 511. Instead of or besides it, the C⁽¹⁾ may send, besides eInfoBA, a certificate guaranteeing that the eInfoBA is a data coming from Service B (the S₂⁽¹⁾), to the S₁⁽¹⁾.

Also, at least a part of the shared data may be a link such an access key (like URL) for Service system being the sharing origin, instead of or besides the data displayed to the user terminal (at least one out of the U_{P} and the U_{M}). Also, the link may be at least a part of the displayed data.

Also, the sharing origin and the sharing destination, not limited to be of 1:1 such as the example above, may be of 1:N (N is an integer greater than or equal to 2), and may be of M:1 (M is an integer greater than or equal to 2).

Also, eInfo is sent from the S₂⁽¹⁾ to the S₁⁽¹⁾ via the C⁽¹⁾ (the storage unit 511), but besides, any one out of the following (a) to (c) may be adopted:

(a) the C⁽¹⁾ requests the S₂⁽¹⁾ to send InfoB to Service A (the S₁⁽¹⁾). The S₂⁽¹⁾, in response to the request, sends eInfo (or InfoB (non-encrypted sharing target data)) to the S₁⁽¹⁾;

(b) the C⁽¹⁾ requests the S₂⁽¹⁾ to obtain Info from Service B (the S₂⁽¹⁾). The S₁⁽¹⁾, is response to the request, obtains eInfoBA (or InfoB) from S₂⁽¹⁾;

(c) S₂⁽¹⁾ sends the link representing the address at which eInfoBA (or InfoB) exists (a storage apparatus inside or outside of the S₂⁽¹⁾), to the C⁽¹⁾. The C⁽¹⁾, in accordance with the link, obtains eInfoBA (or InfoB), and sends the eInfoBA (or InfoB) to the S₁⁽¹⁾, or, the C⁽¹⁾ sends the link to the S₁⁽¹⁾, and the S₁⁽¹⁾, in accordance with the link, obtains eInfoBA (or InfoB).

Information sharing at Embodiment 8 can be expected to be applied to various cases such as submitting U's certificate (for example, a certificates of graduation, a certificates of qualification, a certificate of tax payment, a property register book, etc.) from the university or the organization managing the certificate to a company etc., delivering medical records among hospitals, delivering personal identity numbers (and their accompanying data) among companies, etc.

According to Embodiment 8, it can be expected that U can rely on the information sharing. Because, Sᵢ⁽¹⁾ can be expected to be registered to C⁽¹⁾ in case of being recognized in view of the credibility etc.

At at least one out of Embodiments 7 and 8, at least one of the following (01) up to (05) may be adopted.

(01) At least a part of sharing target data may be non-encrypted. Whether to be encrypted at least a part of sharing target data, may be determined by the user (for example, at Step 2501, the user may determine whether to encrypt or not, for each sharing target data), and whether to be encrypted by the sharing origin service system may be controlled according to the importance or the classification of the sharing target data.

(02) EK₁⁽¹⁾ (encryption key) for the sharing target data may be the public key of the S₁⁽¹⁾, and DK₁⁽¹⁾ (decryption key) of the sharing target data may be the secret key of the S₁⁽¹⁾. Also, the encryption key/decryption key may a key of other type such as a shared key etc. instead of the public key/secret key. Also, the key may be delivered between the S₁⁽¹⁾ and the S₂⁽¹⁾ via the user terminal (Specifically, for example, it may be sent from the S₂⁽¹⁾ to the C⁽¹⁾, sent from the C⁽¹⁾ to the U_{M} (displayed to the screen of the U_{M} by U_{M}), input to the U_{P}, and sent from the U_{P} to the S₁⁽¹⁾), may be delivered between the S₁⁽¹⁾ and the S₂⁽¹⁾ without via the user terminal (Specifically, for example, it may be sent from the S₂⁽¹⁾ to the S₁⁽¹⁾ via (or without via) the C⁽¹⁾), and may be shared between the S₁⁽¹⁾ and the S₂⁽¹⁾ in advance.

(03) For example, in the case where at least a part of the sharing target data is non-encrypted, the C⁽¹⁾ may check whether the sharing target data is innocuous or not (for example, whether it may be displayed or not), that is, the presence of malware (such as virus or remote manipulate program, etc.)

(04) In Embodiment 8, a request of tpw issuance can combine a request of information sharing (a request for sharing data among service systems), but the request of information sharing may become independent of the request of tpw issuance. Namely, U_{M}, at another timing than issuing a request of rpw issuance, may send a request of information sharing (such as a request of sharing data from Service A (the S₁⁽¹⁾) to Service B (the S₂⁽¹⁾)). In that case, as the response to the request of information sharing, the information sharing above may be performed.

(05) In Embodiment 8, both the sharing origin and the sharing destination are chosen by the U, but at least one out of the sharing origin and the sharing destination may be all of the systems the U can use (all service system that the C⁽¹⁾ can identify for the U in the aList⁽¹⁾).

In the following, we summarize Embodiments 1 to 8. Here in the description of the summaries, we can appropriately add new descriptions of modified examples etc. for at least one among Embodiments 1 to 8.

According to Embodiments 1 to 8, Sᵢ^{(j)}, in case of receiving mIDᵢ^{(j)} and tpw from C^{(j)}, becomes of a state possible to receive a request for service (such as a log in request) from the U, and in the case where the expiration date of tpw has passed, becomes of a state impossible to receive a request for service (such as a log in request) from the U. The former state is a state in which the authentication shutter is open, and the latter state is a state the authentication shutter is closed. “An authentication shutter” is a logical shutter to control acceptance of authentication requests. If the authentication shutter is open, then Sᵢ^{(j)}, in case of receiving an authentication request with uIDᵢ^{(j)} and tpw, performs the judgement (authentication) of whether the uIDᵢ^{(j)} and the tpw are correct or not. On the other hand, if the authentication shutter is closed, then without doing judgement of whether the uIDᵢ^{(j)} and the tpw are correct or not, Sᵢ^{(j)} rejects the authentication request. Being bygone for the expiration date of tpw means that the state of the authentication shutter turns from open to closed, but the change from open to closed of the authentication shutter may be performed responding to the request from the U.

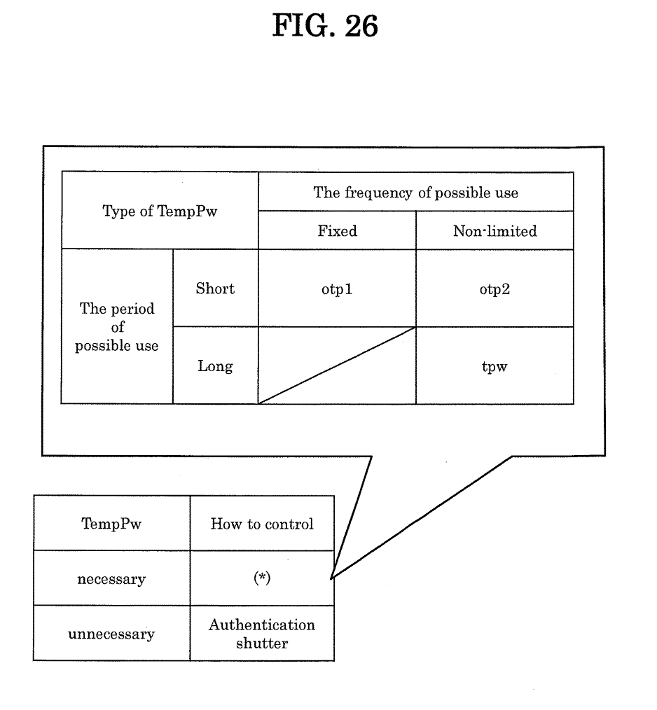

FIG. 26 shows an example of the abstract of the identification code management.

In FIG. 26, “TempPw” has the meaning of temporary passwords as described above, is of the concept including general otp (one-time password), not limited to tpw. According to FIG. 26, we can see the relationship between TempPw and the control system.

In the case where TempPw is needed, the type of TempPw shall vary according to whether the period for possible use (the period until the expiration data) is short (for example, for a few minutes) or long (for example, longer than the period for the “short”), and according to whether the frequency of possible use is fixed or unlimited. Specifically, for example, in the case where the period for possible use is “short” and that the frequency of possible use is “fixed”, the TempPw used may be a general otp (such as an otp for which the frequency of possible use is limited to once). In the case where the period for possible use is “long” and that the frequency of possible use is “unlimited”, the TempPw used is acceptable to be tpw described above.

TempPw is not always necessary. There is a case in which TempPw is not necessary. In that case, it does only with the control using the authentication shutter described above. Combination of an authentication shutter and TempPw is also possible.

In the following, we describe the control of the authentication shutter for which TempPw (such as tpw) is not used. Here, in the following, for readability of description, we suppose that only C⁽¹⁾ is provided as C^{(j)}, and that plural Sᵢ⁽¹⁾ including the S₁⁽¹⁾ and the S₂⁽¹⁾ are provided as Sᵢ^{(j)}.

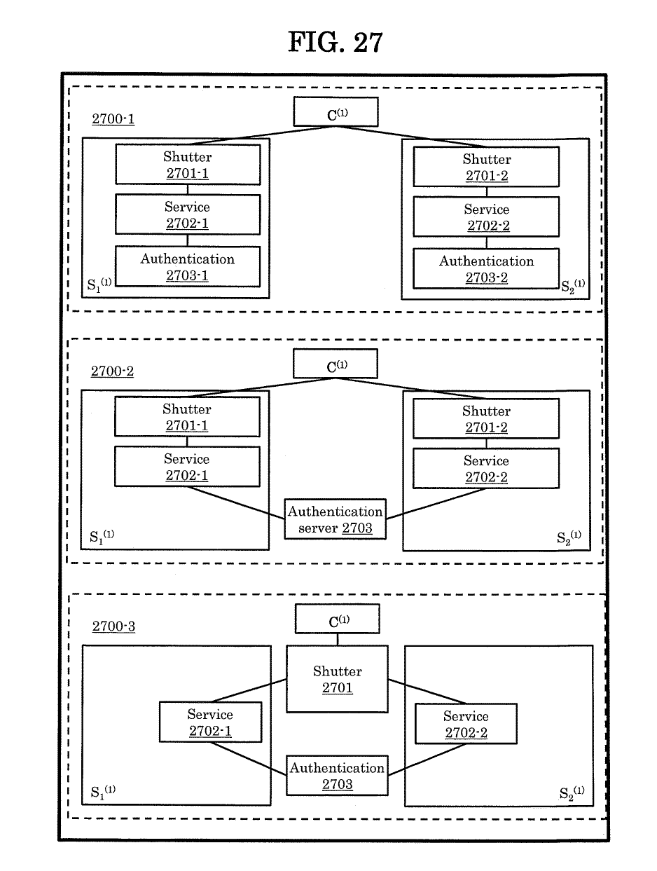

As shown in Reference code 2700-1 in FIG. 27, Sᵢ⁽¹⁾ has plural functions of Shutter management server 2701-i that controls the switch of the authentication shutter, Service server 2702-i that provides service in the case where the authentication is successful, and Authentication server 2703-i that performs authentication. Namely, S₁⁽¹⁾ has Shutter management server 2701-1, Service server 2702-1 and Authentication server 2703-1, and S₂⁽¹⁾ has Shutter management server 2701-2, Service server 2702-2 and Authentication server 2703-2.

Out of Shutter management server 2701-i, Service server 2702-i and Authentication server 2703-i, any of Shutter management server 2701-i and Authentication server 2703-i can be shared by plural S₁⁽¹⁾.

Specifically, for example, as shown in Reference code 2700-2 in FIG. 27, Authentication server 2703 may exist outside the S₁⁽¹⁾ and the S₂⁽¹⁾, and Authentication server 2703 may be shared by the S₁⁽¹⁾ and the S₂⁽¹⁾. Furthermore, as shown in Reference code 2700-3 in FIG. 27, Shutter management server 2701 also may exist outside the S₁⁽¹⁾ and the S₂⁽¹⁾, and Shutter management server 2701 may be shared by the S₁⁽¹⁾ and the S₂⁽¹⁾.

In the following, taking the construction shown by Reference code 2700-1 as the example, we describe the control of the authentication shutter. Here, in the following description, we take, as the example, the S₁⁽¹⁾ out of the S₁⁽¹⁾ and the S₂⁽¹⁾.

In the control of the authentication shutter, Registration procedure #1, Registration procedure #2, Authentication shutter operation procedure and Login procedure are performed.

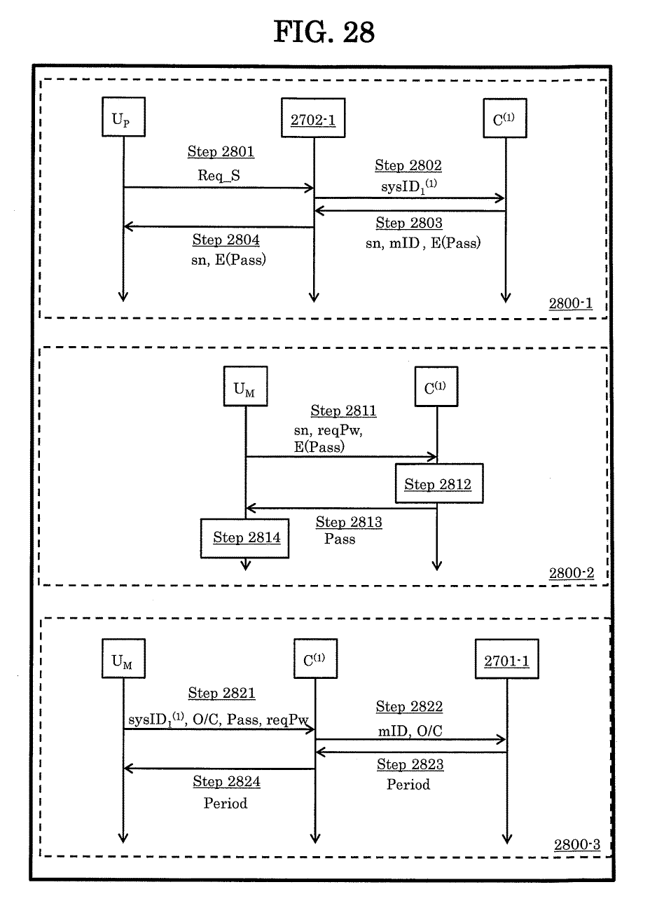

In Registration procedure #1, the flow shown in Reference code 2800-1 in FIG. 28 is performed.

Namely, U_{P} sends a request (Req_S) to Service server 2702-1 (Step 2801). The service server 2702-1, responding to the request, sends a request of user addition to the C⁽¹⁾ (Step 2802).

The C⁽¹⁾ generates a unique mID (mID₁), generates a digital signature Sign for sysID₁⁽¹⁾ and data on the concerned account (U's account) (for example, invariant data that is for the concerned account and that is stored in a list the C⁽¹⁾ keeps, such as the date of the account generation, etc.), and generates an application pass for authentication shutter controls (Pass=(mID, sysID, Sign)). Furthermore, C⁽¹⁾ generates a key, and encrypts Pass using the key. Pass after being encrypted is denoted by E(Pass). Here, since it is only once at this moment that the C⁽¹⁾ encrypts Pass, since it is the C⁽¹⁾ itself to decrypt the encrypted Pass, and since Pass itself is of not so large size, Vernam cipher may be adopted with one-time keys.

Also, the C⁽¹⁾, to the concerned account, sets the value of ust (the state of the U) to be “halfway” (on the way through registration). ust (the state of the U), for example, may be included in OTHERS in aListᵢ⁽¹⁾. The C⁽¹⁾, associating with sn, stores mID, key and ust in aList⁽¹⁾. The C⁽¹⁾ sends sn, mID and E(Pass) to the service server 2702-1 (Step 2803).

The service server 2702-1 registers, in the uList₁⁽¹⁾, uID₁⁽¹⁾ and mID, sets the value of sst (the state of the authentication shutter) to be “closed” (the value meaning the state of closed), and sets the value of period (the time when the authentication shutter becomes of the state closed) to be “undefined”. sst and period are included in at least one out of TPWINFO and OTHERS. After that, the service server 2702-1 sends sn and E(Pass) to U_{P} (Step 2804).

In the registration procedure #2, the flow shown in Reference code 2800-3 in FIG. 28 is performed.

The sn and E(Pass) that the U_{P} receives are input, by the U, to the U_{M}. For the input to the U_{M} for data the U_{P} receives, two-dimensional bar codes etc. may be used, and manual input may be used. The sn and the E(Pass) are input to the U_{M} such as the APP.

After that, by the U, the authentication shutter control password (reqPw) is input to U_{M}. Here, in this description, for simplicity, we suppose that there is one control center machine (C⁽¹⁾), and that tReqPw=reqPw. The U M sends the sn, the reqPw and the E(Pass) to the C⁽¹⁾ (Step 2811). The C⁽¹⁾ identifies the account with sn, and in only case that ust registered as the account data is “halfway”, obtains Pass decrypting E(Pass) using the key for the concerned account. After that, the C⁽¹⁾ verifies the validity of Pass, and in the case where it is valid, sets the value of hreqPw to be “h(reqPw)” (the value being applied to an irreversible transformation process for reqPw), and the value of ust to be “active” (a value meaning being registered) (Step 2812). In addition to ust, hreqPw also may be included in, for example, OTHERS in aList⁽¹⁾. Here, in the case where ust is already “active”, or in the case where Pass is invalid, the C⁽¹⁾ may stop the procedure to be failure at that time.

In the case where Pass is valid, the C⁽¹⁾ sends the Pass to the U_{M} (Step 2813). The U_{M} stores the received Pass after encrypting it with the key of U_{M} specific data (such as MAC address, UUID, etc.) (Step 2814).

At Authentication shutter operation procedure (when the U opens or closes the authentication shutter), the flow shown at Reference code 2800-3 in FIG. 28.

The U_{M}, with the U_{M} specific data, decrypts the encrypted data such as Pass. The U_{M} receives the input of sysID₁⁽¹⁾ (the system ID for the service system (the system ID for S₁⁽¹⁾) whose authentication shutter is operated), the operation content (open or close (O/C)) and reqPw from U, and sends those data and Pass to C⁽¹⁾ (Step 2821).

The C⁽¹⁾ identifies the account with mID included in Pass, and verifies the validities of Pass and reqPw. In the case where those are valid (and correct, respectively), the C⁽¹⁾ sends mID and the operation content (O/C), to the shutter management server 2701-1 (Step 2822).

The shutter management server 2701-1, if the operation content is open, determines the time to close the authentication shutter, and sets the value of period for the U (period identified with the key of mID) to be “t”. Because the timing to open the authentication shutter seems to be the time when the U intends to use the S₁⁽¹⁾ from now, “t” may be the time after a few minutes later since the operation content is received. The shutter management server 2701-1, if the operation content is close, sets the value of period for U to be “Undefined”.

After that, the shutter management server 2701-1 updates set and period for the U, and returns period to the C⁽¹⁾ (Step 2823). The C⁽¹⁾ sends the period to the U_{M} (Step 2824).

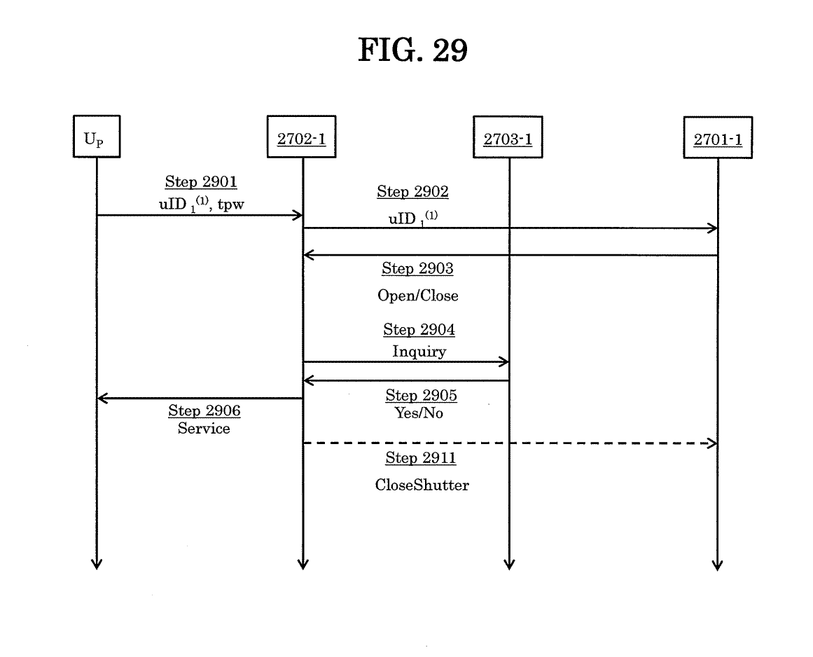

In Login procedure, the flow shown in FIG. 29 is performed.

The U_{P}, responding to the instruction from the U, sends uID₁⁽¹⁾ and pw to the service server 2702-1 (Step 2901). The pw may be a fixed password or TempPw. The service server 2702-1 sends an inquiry associated with uID₁⁽¹⁾ (an inquiry for the state of the authentication shutter for the U), to The shutter management server 2701-1 (Step 2902).

The shutter management server 2701-1 identifies sst and period with the key of uID₁⁽¹⁾. In the case where the time is not after period, the shutter management server 2701-1 returns the value of sst (“open” or “closed”) to the service server 2702-1 (Step 2903). In the case where the time is after period, the shutter management server 2701-1 returns “closed” as the value of sst to the service server 2702-1. Also, in the case where the uID₁⁽¹⁾ does not exist, or in the case where the value of period is “Undefined”, the shutter management server 2701-1 returns “closed” as the value of sst to Service server 2702-1.

The service server 2702-1, in only case that “open” is returned as the value of sst, inquiries (the uID₁⁽¹⁾, the pw) to the authentication server 2703-1 (Step 2904). In the case where “open” is not retuned as the value of sst, the service server 2702-1 may finish the procedure recognizing the login authentication to be failed.

The authentication server 2703-1, responding to (the uID₁⁽¹⁾, the pw), returns Yes or No to the service server 2702-1 (Step 2905).

The Service server 2702-1, in only case that Yes is returned, provides service for the U_{P} (for example, recognizes the login authentication to be successful).

As many a Web application, in the case where the authentication gets successful, delivers Cookie to the browser of the U, also in the control of authentication shutters, according as the service server 2702-1 delivers Cookie to the U_{P} in the case where the authentication gets successful, the U_{P} does not have to do the Authentication procedure for every moving inside the site. In case of the authentication succeeded (in the case where Yes is returned), according as the service server 2702-1 sends a request for closing the authentication shutter to the shutter management server 2701-1, spoofed login by others can be prevented after the U has logged in.

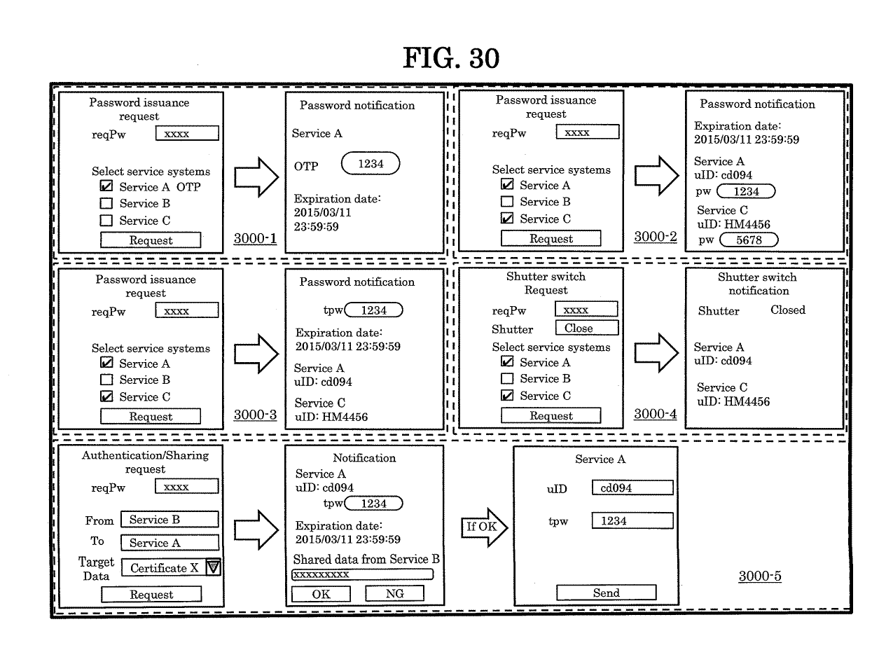

FIG. 30 shows examples of the screen transition at the U_{M} or the U_{P}.

Reference code 3000-1 is an example of the screen transition in the case where the period for possible use of tpw is short and that the frequency of possible use is fixed. In this case, as described above, general otp can be used. Hence, for example, according to the U, to the display of U_{M}, tReqPw⁽¹⁾ (reqPw, accurately) and the designated service system (Service A), OTP “1234” that is available only for Service A is issued by the C⁽¹⁾, and the OTP is displayed to the U_{M}.

Reference code 3000-2 is an example of the screen transition in the case where the period for possible use of tpw is long and that the frequency of possible use is unlimited. In this case, as described above, a shared tpw is used, but Reference code 3000-2 shows an example in which passwords distinct for every service system are issued. For example, according as the U inputs tReqPw⁽¹⁾ and one or more service systems (Service A and Service C) to the display of the U_{M}, the passwords “1234” and “5678” corresponding to Service A and Service C respectively are issued by the C⁽¹⁾, and those passwords are displayed to the U_{M}.

Reference code 3000-3 is an example of the screen transition in the case where the period for possible use of tpw is long and that the frequency of possible use is unlimited. In this case, as described above, the pw is used. For example, according as the U, to the display of the U_{M}, inputs tReqPw⁽¹⁾ and one or more service systems (Service A and Service C) to which sharing tpw is designated, tpw “1234” that is shared by Service A and Service C is issued by the C⁽¹⁾, and the tpw is displayed to U_{M}. At that time, as shown by the figure, the expiration date that is represented by period included in tpwInfo associated with tpw, and uID included in tpwInfo (uID for every service system chosen by the U) may be displayed.

Reference code 3000-4 is an example of the screen transition for the case of switching the authentication shutter. For example, according as the U, to the display of the U_{M}, inputs tReqPw⁽¹⁾, the operation content (for example, Close) and one or more service systems (Service A and Service C), the state of each authentication shutter for the U out of Service A and Service C is set to be as the operation content, and the result is displayed to the U_{M}. At that time, as shown by the figure, in addition to period, tpwInfo including uID for every service system the user chooses may be sent to U_{M}, and uID included in the tpwInfo (uID for every service system chosen by the U) may be displayed, too.

Reference code 3000-5 is an example of the screen transition for authentication/sharing. For example, as shown in Reference code 3000-5, the U inputs (or chooses), to the display of the U_{M}, the sharing origin service system (From) (such as the S₂⁽¹⁾ at FIG. 25), the sharing destination service system (To) (such as S₁⁽¹⁾ at FIG. 25) and the sharing target data (for example, “Certificate X”), and the U_{M} (APP) sends those to the C⁽¹⁾. Here, “Certificate X” is the sharing target data, and is also the value of att in information sharing. Namely, in the example at this figure, the sharing target data is the value of one att. Thus, the desired att may be designated by the U, and for the att, both check of offerability and acceptability may be performed. The U_{M} (APP) displays, in addition to tpw from the C⁽¹⁾, uID, at least a part of the sharing target data and the replay button (OK button and NG button). In the case where the key for the sharing target data is delivered via the user terminal, the key also may be displayed by the U_{M} (APP). In the case where OK button is pushed, the U, using the U_{P}, may access to the sharing destination service system.

Thus, whereas we have described some embodiments, the present invention is never restricted to those embodiments.

For example, in the case where authentication using bio-information with mobile terminals is generalized, by combining it, two-factor authentication without information by memory, or three-factor authentication can be expected. For example, in the case where the U_{M} gets available via biometrics authentication (such as fingerprint authentication or iris authentication) with U_{M}, the bio-information of the U (such as fingerprint authentication or iris authentication) may be used for generation of tReqPw⁽¹⁾ by the U_{M}. For example, instead of or besides reqPw, bio-information of the U may be used. The used bio-information may be data detected by the U_{M}, and may be data pre-registered in the U_{M}.

Also, tpwInfoᵢ^{(j)} may include digital object (such as text or image) for identity certificate to be displayed on the screen that Sᵢ^{(j)} provides for the U (for example, the screen for receiving application such as login screen, the screen for receiving an input of bank account numbers etc.). The object for identity certificate in tpwInfoᵢ^{(j)} may be displayed to the display 211 by U_{M} (APP). U, before inputting data to the screen provided by Sᵢ^{(j)}, compares the object for identity certificate on the screen with the identity certificate code displayed to the touch panel type display 211 by the U_{M} (the object for identity certificate in tpwInfoᵢ^{(j)}). If those coincide, then we can see that the screen provided by U_{M} is, indeed, the screen provided by Sᵢ^{(j)}. Thus, it can be prevented for the U to offer data to unauthorized systems (for example, to became a victim by phishing).

Also, sysIDᵢ^{(j)} related to a request of tpw control such as a request of tpw issuance, may be all (or a part of) sysIDᵢ^{(j)} that are registered in pList and that are automatically chosen by U_{M} (APP), instead of sysIDᵢ^{(j)} for the service systems manually chosen by the U.

Also, at least one of the restrictions for tpw (for example, at least one out of the expiration date and the frequency of possible use) may be determined by the control center machine issuing tpw, instead of the service system. Taking the expiration date as the example, it is as follows. Namely, the expiration date is determined by the control center machine, the expiration data determined by the control center machine sends to the service system via or without via another control center machine. Specifically, for example, the C⁽¹⁾ determines the expiration date for every sysIDᵢ^{(j)} in SYSIDPart (die example, at any one among Steps 1402 to 1404). The expiration date may be identical for all sysIDᵢ^{(j)} in SYSIDPart, and may be distinct for every sysIDᵢ^{(j)} in SYSIDPart. For example, the expiration date (Period₁⁽¹⁾) corresponding to the S₁⁽¹⁾ under the management by the C⁽¹⁾ that determines the expiration date for tpw is sent from the C⁽¹⁾ to the S₁⁽¹⁾. Also, for example, the expiration date (Period₁⁽²⁾) corresponding to the S₁⁽²⁾ under the management by another control center machine the C⁽²⁾ other than the C⁽¹⁾ is sent from the C⁽¹⁾ to the S₁⁽²⁾ via or without via the C⁽²⁾. Sᵢ^{(j)} registers the received expiration date for tpw (Periodᵢ^{(j)}) in uListᵢ^{(j)} as at least a part of tpwInfoᵢ^{(j)} (for example, Step 1405). The process above may be applied to a restriction other than the expiration date for tpw (such as the frequency of possible use).

Also, at least one of the restrictions for tpw (for example, at least one out of the expiration date and the frequency of possible use) may be determined by the user instead of the service system. Taking the expiration date as the example, it is as follows. The expiration date is input to the U_{M} (APP) by the U, is sent from the U_{M} (APP) to the control center machine, and is sent from the control center machine to the service system via or without via another control center machine. Specifically, for example, the U_{M} (APP) receives the input on the expiration date for tpw (Periodᵢ^{(j)}) for each sysIDᵢ^{(j)} in SYSIDPart, from the U (for example, Step 1401). The expiration date may be identical for all sysIDᵢ^{(j)} in SYSIDPart, and may be distinct for every sysIDᵢ^{(j)} in SYSIDPart. The expiration date for tpw (Periodᵢ^{(j)}) for each sysIDᵢ^{(j)} in SYSIDPart is sent from the U_{M} (APP) to C⁽¹⁾ (for example, Step 1401). After that, for example, the expiration date for tpw (Period₁⁽¹⁾) corresponding to the S₁⁽¹⁾ under the management by the C⁽¹⁾ that receives the expiration date for tpw from the U_{M}, sent from the C⁽¹⁾ to the S₁⁽¹⁾. Also, for example, the expiration date for tpw (Period₁⁽²⁾) corresponding to the S₁⁽²⁾ under the management by another control center machine C⁽²⁾ other than the C⁽¹⁾, sent from the C⁽¹⁾ to the S₁⁽²⁾ via or without via the C⁽²⁾. Sᵢ^{(j)} registers the received expiration date for tpw (Periodᵢ^{(j)}) in uListᵢ^{(j)} as at least a part of tpwInfoᵢ^{(j)} (for example, Step 1405). The process above may be applied to a restriction other than the expiration date for tpw (such as the frequency of possible use).

Also, at least a part of the process described above that each of C^{(j)}, Sᵢ^{(j)}, the U_{P} and the U_{M} does, as described above, is performed according as a processor executes computer programs. Also, “servers” described above may be physical server machines instead of functions executed by computer systems (such as virtual servers). C^{(j)} and Sᵢ^{(j)} are, typically, owned or managed by different entities, but may be owned or managed by the identical entity.

Also, the exchange between the U and Sᵢ^{(j)} at least registration phases may be performed on paper base not limited to on Web base. Here, in the description above, according to the table operations at the processes performed by responding to a request from Sᵢ^{(j)} to C^{(j)}, a record (an account) is added in the table, and data is registered to the record by the table operation at the process performed responding to the request from U_{M} to C^{(j)}.

Also, a key such as aID^{(j)} for aggregating plural service systems may be stored in at least one out of the U_{M} and C^{(j)}.

Also, aID^{(j)} is not mandatory. For example, since mIDᵢ^{(j)} are distinct for the identical Sᵢ^{(j)} if the U are distinct, mIDᵢ^{(j)} may be used as aID^{(j)}. However, since, in the case where the number of Sᵢ^{(j)} U uses is large, it is possible to assign two or more Sᵢ^{(j)} U uses with the identical aID^{(j)}, we can expect efficiency by the existence of aID^{(j)}.

Also, in tpwInfoᵢ^{(j)} U_{M} receives, the link (such as URL) to the service system may be included for every service system (for example, for every service system being an issuance destination of tpw, or, for every service system being a sharing destination for sharing target data). U_{M} (or U_{P}) may access to the service system designating the link in tpwInfoᵢ^{(j)}. Here, in the link (URL) included in tpwInfoᵢ^{(j)}, data for identifying U may be included. The service system accessed from U_{M} (or U_{P}) designating the link, may provide a screen in which data (for example, uID and authentication data) shall be input to the input field, to the access origin U_{M} (or U_{P}).

Also, at least one of the embodiments at which tpw is used, in a request sent from the U_{P} (or the U_{M}) to Sᵢ^{(j)} (such as login request), in addition to tpw, a password specific to the Sᵢ^{(j)} may be used. Also, at at least one of the embodiments, digital signatures are not mandatory.

### REFERENCE SIGNS LIST

101 . . . Control center machine, 103 . . . Service system, 105 . . . User terminal

1. A server system designed to communicate with plural user terminals and plural service systems, comprising:
a storage unit configured to store management information; and
a processor coupled to the storage unit, wherein
the management information includes one or more information element groups for each user, each of the one or more information element groups includes mID being an ID which is shared by a server system and a service system and which is distinct for every user,
the processor is configured to
(A) receive a request from a user terminal,
(B) identify, on the basis of the received request, one or more mIDs respectively corresponding to one or more service systems, from the management information, for the user for the user terminal,
(C) send, to each of the one or more service systems, a request associated with the mID(s) corresponding to the service system among the identified one or more mIDs, and control content(s) for the service system.

2. The server system according to claim 1, wherein
each of the information element groups, for each user, includes
a sysID which is an ID for a service system that the user may use, and
an aID which is an ID shared by the service system and a user terminal for the user,
the request received at (A) is a request on a control of an identification code, and is an identification code control request associated with an aID,
the processor is configured to, at (B), identify, from the management information, one or more mIDs which corresponds to aID with which the received identification code control request are associated, and
the processor is configured to, at (C), sends, to each of the one or more service systems, for an identification code common among the one or more service systems, a request associated with the mID(s) corresponding to the service system among the identified one or more mID, and a control content(s) for the identification code.

3. The server system according to claim 2, wherein
the request received at (A) is associated with a sysID for a service system chosen by a user, and
the processor is configured to, at (B), identify, from the management information one or more mIDs corresponding to an aID and a sysID with which the received identification code control request is associated.

4. The server system according to claim 2, wherein
an aID with which the identification code control request is associated, is associated with a digital permit that is issued for the user terminal at a registration phase for registering a service system,
the received identification code control request is associated with tReqPw which is a password input to the user terminal by a user or a password based on the input password, and which is a password for authentication for the request, and
the processor is configured to perform a first judgement of whether the tReqPw identified with the received identification code control request is valid or not, and a second judgement of whether a permit with which the received identification code control request is associated is correct or not, and perform (B) in the case where both judgement result are positive.

5. The server system according to claim 4, wherein
the processor is configured to, in the registration phase,
(a) receive a sysID for the service system from the service system, sends an mID corresponding to the user and the service system, and cID being an ID for the server system, to the service system, and registers an information element group including the received sysID and the sent mID, to the management information,
(b) in response to a request from the user terminal, add an aID and a tReqPw which is a password input by the user for the user terminal or which is a password generated based on the input password, to the information element group registered at (a), and send a permit including an SN being an ID for the information element group registered at (a), an aID registered to the information element group, and a cID, to the user terminal,
the first judgement is a judgement of whether a tReqPw in an information element group identified with a permit with which the received identification code control request is associated, and a tReqPw identified with the received identification code control request, coincide with each other, or not, and
the second judgement is a judgement of whether data obtained from an information element group identified with the permit with which the received identification code control request is associated, and data obtained from the permit with which the identification code control request is associated, coincide with each other, or not.

6. The server system according to claim 4, wherein
the tReqPw is a password generated using a password input by the user and a random number determined by the user terminal or the processor.

7. The server system according to claim 4, wherein
an aID for at least one information element group out of two or more information element group including an identical aID, is an aID generated by the processor in the registration phase corresponding to the information element group, and the processor is configured to send the aID generated in the registration phase to the user terminal, and
an aID for at least one other information element group out of the two or more information element group, is an aID which the processor receives from the user terminal in the registration phase corresponding to the information element group, and is an aID which the user terminal has already stored.

8. The server system according to claim 2, wherein
the received identification code control request is an identification code issuance request which is a request of issuance of an identification code,
the processor is configured to, at (C), generate a common identification code among the one or more service systems,
the request sent at (C) is associated with the common identification code,
the control content(s) in the request sent at (C) is registration for the common identification code,
the common identification code is an identification code input by the user terminal or another user terminal, for any service systems among the one or more service systems.

9. The server system according to claim 2, wherein
the processor is configured to receive, from each of the one or more service system, an encrypted uID being a uID registered to the service system (a user ID) encrypted with an suKey (encryption/decryption key) common among the service system and the user terminal, at the timing of a request at (C) or at another timing other than it, and
the processor is configured to send one or more encrypted uIDs respectively received from the one or more service system, to the user terminal.

10. The server system according to claim 2, comprising:
a first identification code control apparatus comprising the storage unit and the processor; and
a second identification code control apparatus which can communicate with the first identification code control apparatus and plural service systems, wherein
the plural service systems includes a first service system registered to the first identification code control apparatus, and a second service system registered to the second identification code control apparatus,
an identification code control request received by the first identification code control apparatus, is an identification code issuance request being a request of issuance of an identification code,
one or more sysIDs with which the identification code issuance request is associated, includes at least sysID for the second service system, and
the first or the second identification code control apparatus is configured to send a request on a common identification code issued by the first identification code control apparatus, to the second service system corresponding to a sysID with which the identification code issuance request is associated.

11. The server system according to claim 10, wherein
the first identification code control apparatus is configured to send a sysID corresponding to the second service system out of sysIDs with which the identification code issuance request is associated, to the second identification code control apparatus, receive an mID corresponding to the second service system from the second identification control apparatus, and send a request associated with the received mID and the common identification code, to the second serviced system corresponding to the mID.

12. The server system according to claim 10, wherein
the first identification code control apparatus is configured to send a sysID corresponding to the second service system out of sysIDs with which the identification code issuance request is associated and the common identification code, to the second identification code control apparatus, and
the second identification code control apparatus is configured to send a request associated with an mID corresponding to the second service system and the common identification code, to the service system corresponding to the second service system.

13. The server system according to claim 10, wherein
the first identification code control apparatus is configured to send a sysID corresponding to the second service system out of sysIDs with which the identification code issuance request is associated, to the second identification code control apparatus,
the second identification code control apparatus is configured to send an assertion being data including an mID corresponding to the second service system, to the second service system, and
the first identification code control apparatus is configured to send a request associated with the common identification code, to the second service system.

14. The server system according to claim 1, wherein
a response for a request sent to the service system, received from the service system, is data kept by the service system, and includes information elements that are permitted to be published to other service systems.

15. The server system according to claim 1, wherein
a request received at (A) represents an information sharing being to share sharing target data in a sharing origin service system with a sharing destination service system, and
in the case where the request received at (A) represents an information sharing,
one or more mIDs identified at (B) includes mIDs for sharing destination service systems for sharing target data, and
the processor is configured to, at (C), send a request being a request of sharing target data, and being associated with an ID for a sharing origin service system, to a sharing origin service system.

16. The server system according to claim 15, wherein
the processor is configured to
(P) receive sharing target data from the sharing origin service system,
(Q) send the sharing target data received, before the sharing destination service system gets able to obtain the sharing target data, to the user terminal,
(R) in response to an NG response for sharing the sharing target data received, disable for the sharing target data to be obtained by the sharing destination service system.

17. The server system according to claim 16, wherein
the processor is configured to
in the case where the sharing target data received is encrypted, store or send without decrypting the sharing target data, and
in the case where the sharing target data received is not encrypted, check the presence of malware.

18. The server system according to claim 1, wherein
the control content(s) with which each of one or more requests is associated, sent at (C), is open or close for an authentication shutter.

19. A system comprising:
a server system designed to communicate with plural service systems, and
an APP being a application program executed in a user terminal, and communicating with the server systems, wherein
the server system is configured to store management information including one or more information element groups, each of the one or more information element groups including mID(s) that is shared the server system and a service system, and that is different for each user, and
the server system is configured to
(A) receive a request from the APP,
(B) identify, on the basis of the received request received one or more mIDs respectively corresponding to one or more service systems, from the management information for, a user for the user terminal,
(C) send, to each of the one or more service systems, a request associated with an mID corresponding to the service system among the identified one or more mIDs and control content(s) for the service system.

20. A method comprising:
keeping management information including one or more information element groups for each user, each of the one or more information element groups including an mID which is an ID that is shared by a server system and a service system and that is different for each user,
receiving a request from a user terminal,
identifying, on the basis of the received request, one or more mIDs respectively corresponding to one or more service system, from the management information, for a user for the user terminal, and
sending, to each of the one or more service systems, a request associated with an mID for the service system among the identified one or more mIDs and control content(s) for the service system.
